(19) United States
(12) Patent Application Publication
(10) Pub. No.: US 2024/0145929 A1
(43) Pub. Date: May 2, 2024

(54) FREQUENCY SELECTIVE REFLECTOR AND REFLECTING STRUCTURE

(71) Applicant: DAI NIPPON PRINTING CO., LTD, Tokyo (JP)

(72) Inventors: Yuichi MIYAZAKI, Tokyo (JP); Hiroyuki ASAKURA, Tokyo (JP); Atsuo NAKAMURA, Tokyo (JP); Takeshi SEKIGUCHI, Tokyo (JP); Shigeki KAWANO, Tokyo (JP)

(73) Assignee: DAI NIPPON PRINTING CO., LTD, Tokyo (JP)

(21) Appl. No.: 18/548,355

(22) PCT Filed: Mar. 4, 2022
(86) PCT No.: PCT/JP2022/009481

§ 371 Date: Aug. 30, 2023

(30) Foreign Application Priority Data
Mar. 4, 2021 (JP) 2021-034138
Jun. 14, 2021 (JP) 2021-098586

(51) Int. Cl. H01Q 15/00; H01Q 15/14

(52) U.S. Cl. CPC H01Q 15/0013; H01Q 15/14

(57) ABSTRACT

A frequency selective reflector including a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; the dielectric layer includes, as the unit structure, at least a first unit structure including three or more of the cell regions of which thickness differs from one another; and a reflection direction of the electromagnetic waves is controlled by controlling a relative reflection phase distribution of the electromagnetic waves by the thickness distribution of the dielectric layer.

### TECHNICAL FIELD

The present disclosure relates to a frequency selective reflector reflecting electromagnetic waves in a particular frequency band to a direction different from a regular reflection direction, and a reflecting structure including a frequency selective reflector and a protective member configured to protect the frequency selective reflector.

### BACKGROUND ART

To improve the propagation environment and propagation area in a mobile communication system, the technique of the reflect array has been considered. The technique of the reflect array is described, for example, in Patent Document 1 and Patent Document 2, as well as Non-Patent Documents 1 and Non-Patent Document 2. In particular, high frequency radio waves, such as those used in fifth generation communication systems, are strong in straightness, and thus, the resolution of coverage holes is an important issue. Fifth generation communication systems are also referred to as 5G communication systems. Coverage holes refer to regions where radio waves do not reach.

It is desired that the reflect array be capable of reflecting electromagnetic waves to a desired direction relative to electromagnetic waves of a particular frequency incident from a base station in a given direction. In such a reflect array, for example, a plurality of reflective elements arranged. By varying the size and shape of the reflective element, the resonant frequency of each reflective element is varied to control the reflection phase of the electromagnetic wave. A technique for controlling the incident direction and the reflection direction of electromagnetic waves by controlling the reflection phase of electromagnetic waves has been developed.

### CITATION LIST

### Patent Documents

Patent Document 1: Japanese Patent No. 5371633
Patent Document 2: Japanese Patent No. 5162677
Patent Document 3: WO Publication No. 2016/002832

### Non-Patent Documents

Non-Patent Document 1: Hiromi MATSUNO et. Al. “Visible Light Transfer Meta-surface Reflectors”, THE INSTITUTE OF ELECTRONICS, INFORMATION AND COMMUNICATION ENGINEERS, IEICE Technical Report, 2020, Vol. 120, No. 9, pp. 13-17
Non-Patent Document 2: Mayumi YOSHINO et. Al. “Received Power Improvement in NLoS Region of L-Shaped Corridor by Utilizing Meta-Reflector”, THE INSTITUTE OF ELECTRONICS, INFORMATION AND COMMUNICATION ENGINEERS, IEICE Technical Report, AP2020-5(2020-04)

### SUMMARY

### Technical Problem

In the reflect array, the pattern of reflective elements is known to be formed, for example, by etching a metal layer using photolithographic techniques.

Here, in a mobile communication system, the relationship between the position of the base station, the position of the coverage hole, and the installation location of the reflect array is assumed to be a variety of situations. To that end, it is necessary to use a reflect array having reflection properties that are the target incident angle and reflection angle in accordance with the situation.

However, attempting to customize the reflection properties in response to a variety of situations increases the cost of manufacturing the reflect array. This is because the photomask used for photolithographic processing of the metal layer needs to be customized. Thus, it is not practical to customize the reflection properties of the reflect array to a situation. In practice, it has been necessary to use a reflect array with reflection properties that are not optimal for that situation.

Also, in the reflect array, for example, the reflection angle can be increased by narrowing the pitch of the reflective element. However, in the planar arrangement of reflective elements, it is difficult to increase the reflection angle due to limitations in the narrowing of the pitch of the reflective elements. In addition, it is necessary to finely control the reflection phase in the reflect array plane to obtain a reflect array having reflection properties that are the target reflection angle in accordance with the situation. However, since photolithographic processing of a metal layer is limited in processing accuracy, it is difficult to finely control the reflection phase at a high frequency of which the wavelength is short and processing accuracy is required.

The present disclosure has been made in view of the above circumstances, and the first object thereof is to provide a frequency selective reflector that is easy to customize reflection properties.

Incidentally, the reflect array needs to be protected from the external environment. However, when the protective member is placed in the reflect array, there is a problem that the electromagnetic waves are attenuated by the protective member.

Here, there is known a technique for suppressing the attenuation of electromagnetic waves by a radome and suppressing the disturbance of the directivity of the antenna in an antenna device including a radome for protecting the antenna body, but it is a technique for an antenna but not for a reflect array. For example, it is known that the thickness of the radome is one-half of the effective wavelength of the electromagnetic wave or an integer multiple thereof, or a quarter of the effective wavelength of the electromagnetic wave or an integer multiple thereof. For example, it is known that the distance between the antenna and the radome is one-half of the effective wavelength of the electromagnetic wave or an integer multiple thereof. These are described, for example, in Patent Document 3.

Even when the protective member is arranged in the reflect array, it is considered that the attenuation of electromagnetic waves due to the protective member can be suppressed by setting the thickness of the protective member and the distance between the reflect array and the protective member to specific values as described above. However, the designs of the reflect array and protective member will be limited.

Also, in the reflect array, when the incident angle and the reflection angle of the electromagnetic waves are different, the path length between the incident side surface of the protective member and the reflection array surface is different between the incident wave and the reflected wave. For this reason, when the protective member is arranged in the reflect array, even if the thickness of the protective member and the distance between the reflect array and the protective member are set to specific values as described above, the attenuation of the electromagnetic wave due to the protective member cannot be sufficiently suppressed.

The present disclosure has been made in view of the above circumstances, and a second object thereof is to provide a reflecting structure including a frequency selective reflector that reflects electromagnetic waves in a particular frequency band to a direction different from the regular reflection direction, and a protective member that protects the frequency selective reflector, wherein the reflecting structure is capable of suppressing attenuation of electromagnetic waves by the protective member without limiting the design.

### Solution to Problem

It is a first object of the present disclosure to provide a frequency selective reflector that facilitates customization of reflection properties. The first object is achieved by embodiments of the present disclosure described as below.

One of the embodiments of the present disclosure provides a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, in a graph setting a horizontal axis as a length of the predetermined direction of the unit structure, and setting a vertical axis as a relative reflection phase when the electromagnetic waves are transmitted through the dielectric layer, reflected by the reflecting member and emitted to the incident side of the electromagnetic wave by being transmitted through the dielectric layer again, in the graph, a value of the relative reflection phase of the electromagnetic waves is over −360° and 0° or less, when a point corresponding to a central position of the predetermined direction in each cell region and corresponding to the relative reflection phase of the electromagnetic waves in each cell region are plotted, and a straight line passing through a point corresponding to a minimum thickness cell region having a minimum thickness is drawn, each point is on a same straight line; the dielectric layer includes, as the unit structure, at least a first unit structure including three or more of the cell regions of which thickness differs from one another; and a reflection direction of the electromagnetic waves is controlled by controlling a relative reflection phase distribution of the electromagnetic waves by the thickness distribution of the dielectric layer.

Another embodiment of the present disclosure provides a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, in a graph setting a horizontal axis as a relative position when a central position in the predetermined direction of a minimum thickness cell region having a minimum thickness is defined as 0, and a central position of the predetermined direction of a maximum thickness cell region having a maximum thickness is defined as 1; and setting a vertical axis as a ratio of a thickness of each cell region to a thickness of the maximum thickness cell region when a thickness of the minimum thickness cell region is defined as 0, and a thickness of the maximum thickness cell region is defined as 1; when a point corresponding to a central position of the predetermined direction in each cell region and corresponding to a thickness ratio of each cell region with respect to a thickness of the maximum thickness cell region is plotted to obtain a regression line of a below formula (1):

y=ax (1),

a slope “a” of the regression line is 0.7 or more and 1.2 or less, a coefficient of determination of the regression line is 0.9 or more; and the dielectric layer includes, as the unit structure, at least a first unit structure including three or more of the cell regions of which thickness differs from one another.

Another embodiment of the present disclosure provides a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, a difference between a minimum thickness and a maximum thickness is 0.2 mm or more and 15 mm or less; and the dielectric layer includes, as the unit structure, at least a first unit structure including three or more of the cell regions of which thickness differs from one another.

Another embodiment of the present disclosure provides a dielectric layer to be used for the frequency selective reflector described above.

It is a second object of the present disclosure to provide a reflecting structure including a frequency selective reflector that reflects electromagnetic waves in a particular frequency band to a direction different from a regular reflection direction, and a protective member that protects the frequency selective reflector, wherein the reflecting structure is capable of suppressing attenuation of electromagnetic waves due to the protective member without limiting the design. The second objective is achieved by embodiments of the present disclosure as described below.

Another embodiment of the present disclosure provides a reflecting structure comprising: a frequency selective reflector reflecting electromagnetic waves in a particular frequency band to a direction different from a regular reflection direction; and a protective member arranged in an upper side of the frequency selective reflector, wherein a thickness of the protective member is less than ¼ of an effective wavelength of the electromagnetic waves propagating in the protective member.

### Advantageous Effects of Disclosure

The frequency selective reflector of the present disclosure exhibits the effect of facilitating the customization of the reflection properties. Also, the frequency selective reflector of the present disclosure exhibits the effect of increasing the margin of processing accuracy in controlling reflection properties.

The reflecting structure of the present disclosure exhibits the effect of suppressing the attenuation of electromagnetic waves due to the protective member without limiting the design.

### BRIEF DESCRIPTION OF DRAWINGS

FIGS. 1A to 1C are schematic plan view and cross-sectional views exemplifying the frequency selective reflector of the present disclosure, and a schematic diagram for explaining a relative reflection phase of electromagnetic waves in each cell region of a unit structure of a dielectric layer in the frequency selective reflector of the present disclosure.

FIG. 2 is a schematic diagram exemplifying reflection properties in the frequency selective reflector of the present disclosure.

FIGS. 3A to 3H are schematic perspective views and plan views exemplifying the unit structure of the dielectric layer in the frequency selective reflector of the present disclosure.

FIGS. 4A to 4C are schematic plan views exemplifying the unit structure of the dielectric layer in the frequency selective reflector of the present disclosure.

FIG. 5 is a schematic cross-sectional view exemplifying the frequency selective reflector of the present disclosure.

FIGS. 6A and 6B are a schematic cross-sectional view exemplifying the frequency selective reflector of the present disclosure, and a schematic diagram for explaining the relative reflection phase of electromagnetic waves in each cell region of the unit structure of the dielectric layer in the frequency selective reflector of the present disclosure.

FIG. 7 is a schematic diagram exemplifying reflection properties in the frequency selective reflector of the present disclosure.

FIG. 8 is a schematic plan view exemplifying the unit structure of the dielectric layer in the frequency selective reflector of the present disclosure.

FIGS. 9A to 9C are a schematic cross-sectional view exemplifying the frequency selective reflector of the present disclosure, and schematic diagrams for explaining the relative reflection phase of electromagnetic waves in each cell region of the unit structure of the dielectric layer in the frequency selective reflector of the present disclosure.

FIG. 10 is a schematic diagram exemplifying the structure of the unit structure of the dielectric layer in the frequency selective reflector of the present disclosure.

FIG. 11 is a schematic cross-sectional view exemplifying the frequency selective reflector of the present disclosure.

FIGS. 12A and 12B are a schematic plan view exemplifying a reflecting member in the frequency selective reflector of the present disclosure, and a schematic cross-sectional view exemplifying the frequency selective reflector of the present disclosure.

FIGS. 13A and 13B are a schematic plan view exemplifying the reflecting member in the frequency selective reflector of the present disclosure, and a schematic cross-sectional view exemplifying the frequency selective reflector of the present disclosure.

FIG. 14 is a schematic cross-sectional view exemplifying the frequency selective reflector of the present disclosure.

FIGS. 15A to 15C are a schematic plan view and cross-sectional view exemplifying the frequency selective reflector of the present disclosure, and a graph exemplifying the relation between a relative position and thickness ratio of each cell region of the unit structure of the dielectric layer in the frequency selective reflector of the present disclosure.

FIG. 16 is a graph exemplifying the relation between the relative position and the thickness ratio of each cell region of the unit structure of the dielectric layer in the frequency selective reflector of the present disclosure.

FIGS. 17A and 17B are a schematic cross-sectional view exemplifying a reflecting structure of the present disclosure, and a schematic plan view exemplifying the frequency selective reflector in the reflecting structure of the present disclosure.

FIGS. 18A and 18B are a schematic cross-sectional view exemplifying the reflecting structure of the present disclosure, and a schematic plan view exemplifying the frequency selective reflector in the reflecting structure of the present disclosure.

FIGS. 19A and 19B are a schematic plan view and cross-sectional view exemplifying the reflecting structure of the present disclosure.

FIGS. 20A and 20B are a schematic perspective view showing a simulation model of Example 1, and a graph showing the simulation result.

FIGS. 21A and 21B are a schematic perspective view showing a simulation model of Example 2, and a graph showing the simulation result.

FIG. 22 is a schematic diagram exemplifying a transmission line equivalent circuit.

FIGS. 23A to 23C are a schematic perspective view showing a simulation model of Example 5 and graphs showing the simulation result.

FIGS. 24A to 24C are graphs exemplifying the relation between the relative position and the thickness ratio of each cell region of the unit structure of the dielectric layer in the frequency selective reflector of Example 6.

### DESCRIPTION OF EMBODIMENTS

Embodiments of the present disclosure will be hereinafter explained with reference to, for example, drawings. However, the present disclosure is enforceable in a variety of different aspects, and thus should not be taken as is limited to the contents described in the embodiments exemplified as below. Also, the drawings may show the features of the invention such as width, thickness, and shape of each part schematically in order to explain the invention more clearly in some cases comparing to the actual form; however, it is merely an example, and thus does not limit the interpretation of the present disclosure. Also, in the present description and each drawing, for the factor same as that described in the drawings already explained, the same reference sign is indicated and the explanation thereof may be omitted.

In the present description, upon expressing an aspect of arranging one member on the other member, when it is expressed simply “on” or “below”, both of when the other member is directly arranged on or below the one member so as to contact with each other, and when the other member is arranged above or below the one member further interposing an additional member, can be included unless otherwise described. Upon expressing an aspect of arranging one member above the other member, when it is expressed simply “in upper side” or “down side”, any of when the other member is directly arranged on or below the one member so as to contact with each other, when the other member is arranged above or below the one member interposing an additional member, and when the other member is arranged upward or downward of the one member interposing a space, can be included unless otherwise described. Furthermore, in the present description, upon expressing an aspect of arranging the other member in a surface of one member, when expressed simply “in a surface”, both of when the other member is directly arranged on or below the one member so as to contact with each other, and when the other member is arranged above or below the one member further interposing an additional member, can be included unless otherwise described.

A frequency selective reflector, a dielectric layer used therefor, and a reflecting structure in the present disclosure will be hereinafter explained in.

A. Frequency Selective Reflector

The frequency selective reflector in the present disclosure has three embodiments. In the following, each embodiment will be explained separately.

### I. First Embodiment of Frequency Selective Reflector

The frequency selective reflector in the present embodiment is a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, in a graph setting a horizontal axis as a length of the predetermined direction of the unit structure, and setting a vertical axis as a relative reflection phase when the electromagnetic waves are transmitted through the dielectric layer, reflected by the reflecting member and emitted to the incident side of the electromagnetic wave by being transmitted through the dielectric layer again, in the graph, a value of the relative reflection phase of the electromagnetic waves is over −360° and 0° or less, when a point corresponding to a central position of the predetermined direction in each cell region and corresponding to the relative reflection phase of the electromagnetic waves in each cell region are plotted, and a straight line passing through a point corresponding to a minimum thickness cell region having a minimum thickness is drawn, each point is on a same straight line; the dielectric layer includes, as the unit structure, at least a first unit structure including three or more of the cell regions of which thickness differs from one another; and a reflection direction of the electromagnetic waves is controlled by controlling a relative reflection phase distribution of the electromagnetic waves by the thickness distribution of the dielectric layer.

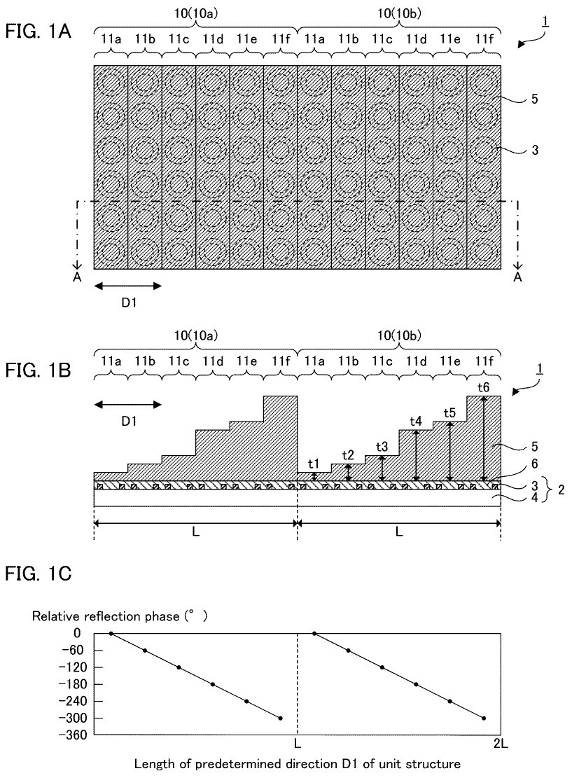

The frequency selective reflector of the present embodiment will be explained with reference to drawings. FIGS. 1A and 1B are a schematic plan view and cross-sectional view showing an example of the frequency selective reflector of the present embodiment, and FIG. 1B is a cross-sectional view of A-A line in FIG. 1A. As shown in FIGS. 1A and 1B, frequency selective reflector 1 includes: reflecting member 2 reflecting particular electromagnetic waves; and dielectric layer 5 that: is disposed at an incident side of the electromagnetic waves with respect to the reflecting member 2; includes a concave and convex structure in which a plurality of unit structure 10 including a thickness distribution of which thickness t1 to t6 increase in predetermined direction D1 is arranged; and transmits particular electromagnetic waves. Also, the frequency selective reflector 1 may include adhesive layer 6 between the reflecting member 2 and the dielectric layer 5. The unit structure 10 of the dielectric layer 5 includes a plurality of cell regions 11a to 11f of which thickness t1 to t6 differs from one another. For example, in FIG. 1B, the unit structure 10 of the dielectric layer 5 has a stepped shape in which the thickness t1 to t6 gradually increase in the predetermined direction D1, the number of steps in the stepped shape is six stages, and the unit structure 10 of the dielectric layer 5 includes six cell regions 11a to 11f. In each cell region 11a to 11f of the unit structure 10 of the dielectric layer 5, since the thicknesses t1 to t6 are different, the round-trip optical path length when the electromagnetic wave is transmitted through the dielectric layer 5, reflected by the reflecting member 2 and is emitted to the incident side of the electromagnetic wave by being transmitted through the dielectric layer 5 again, is different, and these differences in the round-trip optical path length in the dielectric layer, that is the optical path difference, will produce a relative reflection phase difference.

Here, the term “optical path length” is used in the present description to refer to the effective distance when the electromagnetic wave passes through the dielectric layer in practice because the wavelength of the frequency band targeted in the present disclosure is more easily explained when described as behavior similar to the light since the wavelength of the frequency band targeted in the present disclosure is closer to that of the light as compared to the frequency band of a conventional LTE and is high in straightness.

Then, in the unit structure 10 of the dielectric layer 5, in a graph setting a horizontal axis as a length L of the predetermined direction D1 of the unit structure 10, and setting a vertical axis as a relative reflection phase when the electromagnetic waves are transmitted through the dielectric layer 5, reflected by the reflecting member 2 and emitted to the incident side of the electromagnetic wave by being transmitted through the dielectric layer 5 again, in the graph, a value of the relative reflection phase of the electromagnetic waves is over −360° and 0° or less, when a point corresponding to a central position of the predetermined direction D1 in each cell region and corresponding to the relative reflection phase of the electromagnetic waves in each cell region are plotted, and a straight line passing through a point corresponding to a minimum thickness cell region having a minimum thickness is drawn, each point is on a same straight line.

FIG. 1C is a graph setting a horizontal axis as the length L of the unit structure 10 of the dielectric layer 5 in the predetermined direction D1, and setting a vertical axis as a relative reflection phase when the electromagnetic waves are transmitted through the dielectric layer 5, reflected by the reflecting member 2 and emitted to the incident side of the electromagnetic wave by being transmitted through the dielectric layer 5 again, wherein a value of the relative reflection phase of the electromagnetic waves is over −360° and 0° or less; and it is an example of the relative reflection phase of electromagnetic waves in each cell region of the unit structure of the dielectric layer in the frequency selective reflector shown in FIGS. 1A and 1B. As shown in FIG. 1C, the relative reflection phases of electromagnetic waves in each cell region 11a to 11f of the unit structure 10 of the dielectric layer 5 are respectively 0°, −60°, −120°, −180°, −240°, and −300°, and the absolute value of the difference between the relative reflection phases of electromagnetic waves in neighboring cell regions is 60°. In this case, thicknesses t1 to t6 of six cell regions 11a to 11f of the unit structure 10 of the dielectric layer 5 are designed so that the absolute value of the difference between the relative reflection phases of the electromagnetic waves in neighboring cell regions become 360° divided by 6, that is 60°. Then, as shown in FIG. 1C, when a point corresponding to a central position of the predetermined direction D1 in each cell region 11a to 11f of the unit structure 10 of the dielectric layer 5 and corresponding to the relative reflection phase of the electromagnetic waves in each cell region 11a to 11f are plotted, and among each cell region 11a to 11f, a straight line passing through a point corresponding to minimum thickness cell region 11a having the minimum thickness t1 is drawn, each point is on a same straight line. In other words, each point is on the solid line in the graph shown in FIG. 1C.

Here, in the present description, “reflection phase” refers to the amount of change in phase of the reflected wave relative to the phase of the incident wave incident on a surface. In the frequency selective reflector including the reflecting member and the dielectric layer of the present disclosure, it is referred to as the amount of change in phase of the reflected wave when the incident wave is transmitted through the dielectric layer, reflected by the reflecting member and is emitted through the dielectric layer by being transmitted through the dielectric layer again, with respect to the phase of the incident wave.

Also, in the present description, the term “relative reflection phase” is one in which, in one unit structure of the dielectric layer, when the reflection phase in the cell region where the delay of the reflection phase is the smallest is used as a reference, the delay of the reflection phase in a certain cell region with respect to the reflection phase of the reference is shown as a negative signal. For example, in one unit structure of the dielectric layer, when the reflection phase in the cell region where the delay of the reflection phase is the smallest is −10°, the relative reflection phase in the cell region where the reflection phase is −40°, is −30°.

When the reflecting member has a reflection phase control function as described below, the relative reflection phase of the electromagnetic wave in the cell region is a value obtained by synthesizing also the reflection phase at the reflecting member.

Also, in the present description, a “cell region” refers to a region in which the relative reflection phase of an electromagnetic wave is the same in the unit structure of the dielectric layer.

Note that the reflection phase is in the range of over −360° to less than +360° unless otherwise noted, and −360° and +360° return to 0°. Also, the relative reflection phase is in the range of over −360° to 0° or less, unless otherwise noted, and −360° returns to 0°.

In a conventional reflect array in which a plurality of reflective elements arranged, for example, by adjusting the size and shape of the reflective element, the reflection phase can be delayed or the reflection phase can be advanced. In the frequency selective reflector of the present disclosure, the reflection phase is basically delayed by adjusting the thickness of each cell region of the unit structure of the dielectric layer. For this reason, the relative reflection phase is based on the reflection phase in the cell region where the delay of the reflection phase is the smallest.

Also, usually, in one unit structure of the dielectric layer, the cell region where the delay of the reflection phase is the smallest is a minimum thickness cell region having a minimum thickness in a predetermined direction in which the thickness increases. Thus, in the above graph, a straight line is drawn through a point corresponding to the minimum thickness cell region having the minimum thickness.

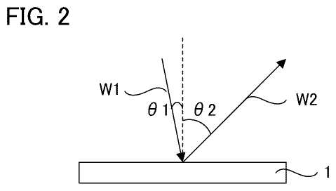

As described above, in each cell region 11a to 11f of the unit structure 10 of the dielectric layer 5, the thickness t1 to t6 varies, thereby the round-trip optical path length in the dielectric layer 5 varies and the relative reflection phase of the electromagnetic wave varies. Thus, as exemplified in FIG. 2, the incident wave W1 of the electromagnetic wave can be reflected to a direction different from the regular reflection direction, that is the specular reflection direction. In this case, the incident angle θ1 of the incident wave W1 of the electromagnetic wave is different from the reflection angle θ2 of the reflected wave W2 of the electromagnetic wave.

Thus, by varying the thickness of each cell region of the unit structure of the dielectric layer, the frequency selective reflector of the present embodiment can vary the round-trip optical path length in the dielectric layer per each cell region and control the reflection phase of the electromagnetic wave. As a result, the direction of reflection of the electromagnetic wave with respect to the predetermined incident direction can be controlled in any direction.

Further, the concave and convex structure of the dielectric layer in the present embodiment can be formed by various techniques such as, for example, cutting, laser processing, using a mold, 3D printer, and joining small piece parts. Therefore, there is no need for a photomask that was required for photolithographic processing of a metal layer in a conventional reflect array. Thus, when the thickness of each cell region of the unit structure of the dielectric layer is designed and the dielectric layer is formed so as to obtain reflection properties with the desired incident angle and reflection angle in accordance with the situation, the desired dielectric layer can be formed with comparatively low cost and short term, which easily meets a small quantity and variety of needs. In addition, for the thickness of the dielectric layer and the size of the unit structure of the dielectric layer that affect the control of the reflection properties, the range of possible processing is relatively wide. Therefore, for example, the incident angle and the reflection angle of the electromagnetic wave can be increased, and the control region of the reflection properties can be widened. Furthermore, with respect to the thickness of the dielectric layer and the pitch of the cell region of the unit structure of the dielectric layer, the margin of dimensional processing accuracy for achieving the desired reflection phase is relatively wide. Therefore, the desired reflection properties can be easily obtained and the influence of dimensional variations can be reduced. Accordingly, it is easy to customize the reflection properties of the frequency selective reflector.

Also, in the frequency selective reflector of the present embodiment, the reflecting member may be a frequency selective plate that reflects only a particular electromagnetic wave. For example, as shown in FIGS. 1A and 1B, the reflecting member 2 is the one in which a plurality of ring-shaped reflective elements 3 arranged, and it includes dielectric substrate 4, and a plurality of reflective elements 3 arranged on the dielectric layer 5 side surface of the dielectric substrate 4.

Further, in the frequency selective reflector of the present embodiment, the reflecting member may be a frequency selective plate that reflects only a particular electromagnetic wave, as well as a member including a reflection phase control function that controls the reflection phase of the electromagnetic wave. Such a reflecting member can vary the resonant frequency per reflective element by varying the size and shape of the reflective element, and can control the targeted reflection phase of the electromagnetic waves. In this case, the reflection phase of the electromagnetic wave can be controlled not only by the thickness of the dielectric layer but also by the size and shape of the reflective element, and the degree of freedom of design for controlling the reflection properties can be improved.

Thus, in the frequency selective reflector of the present embodiment, when such a reflecting member is used, the degree of freedom in controlling the reflection properties can be widened by combining with the dielectric layer. Therefore, customization of the reflection properties of the frequency selective reflector can be made easier. For example, there is an operation where the reflection properties in top and bottom directions may be prepared with multiple types of reflecting members and combined with a dielectric layer that adjusts the reflection properties in horizontal direction.

The inventors of the present disclosure also simulate the reflection properties of electromagnetic waves in a particular frequency band when the reflecting member is a frequency selective plate including a reflective element that reflects only a particular electromagnetic wave in the frequency selective reflector including the reflecting member and the dielectric layer of the present disclosure. This simulation has found that when the thickness of the cell region of the unit structure of the dielectric layer is varied to vary the round-trip optical path length in the dielectric layer per cell region, the deviation of the reflection phase was greater compared to the deviation of the reflection phase in the reflective element due to the proximity of the dielectric layer to the reflecting member, that is, the frequency selective plate. In other words, it has been discovered that the design of substantial reflection properties can be substantially determined by the design of the concave and convex structure of the dielectric layer. At this time, the resonant frequency of the reflective element varies depending on the presence or absence of the adjacent dielectric layer, but if the design is performed on the premise that the dielectric layer is present, the practical problem is solved. Furthermore, the in-plane arrangement of the concave and convex structure of the dielectric layer to achieve an in-plane distribution design of the reflection phase in the frequency selective reflector need not be in a fixed positional relationship with respect to the in-plane arrangement of the reflective element of the reflecting member, and it has been found out that even if the concave and convex structure of the dielectric layer is shifted and arranged with respect to the in-plane arrangement of the reflective element, there is no significant effect on the reflection properties.

Thus, when the dielectric layer and the reflecting member as described above are combined and used in the frequency selective reflector of the present embodiment, it is possible to design each of the dielectric layer and the reflecting member independently, and combine the two. In this case, a dielectric layer for achieving reflection properties according to the use environment may be made each time and a plurality of specifications may be prepared in advance. As a result, it is possible to more easily customize the design of the reflection direction of the frequency selective reflector that changes according to the use environment, and it becomes easy to apply to various situations. Incidentally, as described above, in the case of adjusting the total reflection properties of the frequency selective reflector by the combination of the respective reflection phase distributions of the reflecting member and the dielectric layer, the accuracy of the misalignment of the reflecting member and the dielectric layer according to the required specification is required. On the other hand, when the reflection properties of the frequency selective reflector are adjusted only by the reflection phase distribution of the dielectric layer, the accuracy of the misalignment of the reflecting member and the dielectric layer is not required so much.

In the following, each configuration of the frequency selective reflector of the present embodiment will be described.

1. Dielectric Layer

The dielectric layer in the present embodiment is a member that is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves in a particular frequency band. Also, the unit structure of the dielectric layer includes a plurality of cell regions of which thickness differs from one another; and in each of the unit structure of the dielectric layer, in a graph setting a horizontal axis as a length of the predetermined direction of the unit structure, and setting a vertical axis as a relative reflection phase when the electromagnetic waves are transmitted through the dielectric layer, reflected by the reflecting member and emitted to the incident side of the electromagnetic wave by being transmitted through the dielectric layer again, in the graph, a value of the relative reflection phase of the electromagnetic waves is over −360° and 0° or less, when a point corresponding to a central position of the predetermined direction in each cell region and corresponding to the relative reflection phase of the electromagnetic waves in each cell region are plotted, and a straight line passing through a point corresponding to a minimum thickness cell region having a minimum thickness is drawn, each point is on a same straight line. Also, the dielectric layer includes, as the unit structure, at least a first unit structure including three or more of the cell regions of which thickness differs from one another.

(1) Structure of Dielectric Layer

The dielectric layer includes a concave and convex structure in which a plurality of a unit structure including a thickness distribution of increasing thickness in a predetermined direction is arranged.

The unit structure of the dielectric layer includes a plurality of cell regions of which thickness differs from one another; and in each of the unit structure of the dielectric layer, in a graph setting a horizontal axis as a length of the predetermined direction of the unit structure, and setting a vertical axis as a relative reflection phase when the electromagnetic waves are transmitted through the dielectric layer, reflected by the reflecting member and emitted to the incident side of the electromagnetic wave by being transmitted through the dielectric layer again, in the graph, a value of the relative reflection phase of the electromagnetic waves is over −360° and 0° or less, when a point corresponding to a central position of the predetermined direction in each cell region and corresponding to the relative reflection phase of the electromagnetic waves in each cell region are plotted, and a straight line passing through a point corresponding to a minimum thickness cell region having a minimum thickness is drawn, each point is on a same straight line.

It should be noted that when each point is on the same straight line, the difference in the vertical axis direction of each point with respect to the straight line is within ±72°. The difference in the vertical axis direction of each point relative to the straight line is preferably within ±54°, more preferably within ±36°, and further more preferably within ±18°. In the case where each point includes a deviation in the vertical axis direction with respect to the straight line, and a straight line passing through each point is difficult to be drawn, “a straight line connecting a point corresponding to a minimum thickness cell region having a minimum thickness and a point corresponding to a minimum thickness cell region having a minimum thickness in a unit structure adjacent to the unit structure” may be considered. A point corresponding to the minimum thickness cell region having the minimum thickness is a point of a relative reflectance phase of 0°. A point corresponding to the minimum thickness cell region having the minimum thickness in the unit structure adjacent to the unit structure is a point that can be regarded as a relative reflection phase of −360°.

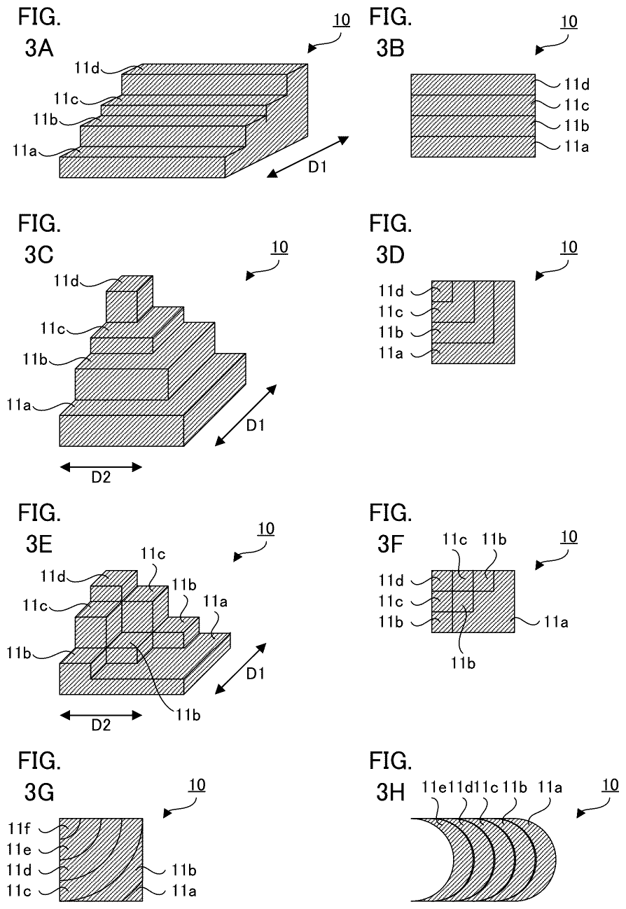

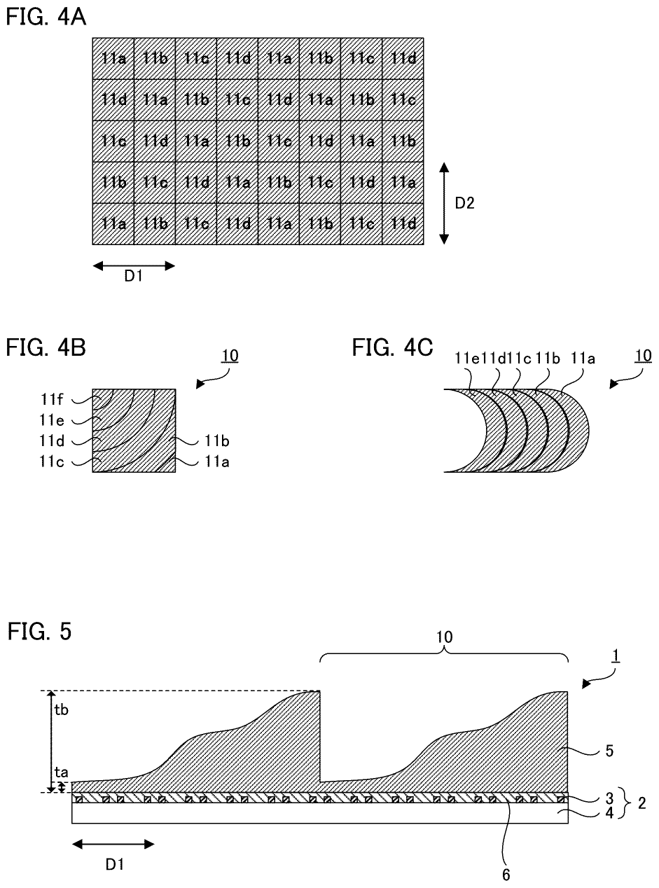

The unit structure of the dielectric layer includes a thickness distribution of increasing thickness in a predetermined direction. The unit structure of the dielectric layer may include, for example, a thickness distribution that increases in thickness in only one direction. Alternatively, the unit structure of the dielectric layer may include a thickness distribution that increases in thickness in two directions that are a first direction and a second direction perpendicular to the first direction. For example, FIG. 3A is an example in which the unit structure 10 of the dielectric layer includes a thickness distribution in which the thickness increases only in the first direction D1, and FIGS. 3C, 3E, and 4A are examples of a thickness distribution in which the thickness of the unit structure 10 of the dielectric layer increases in the first direction D1 and the second direction D2.

If the unit structure of the dielectric layer includes a thickness distribution that increases in thickness only in one direction, then each point will be on the same straight line when plotting the above points in the graph with the length of the unit structure in one direction as the horizontal axis. Also, when the unit structure of the dielectric layer includes a thickness distribution in which the thickness increases in two directions perpendicular to each other, each point is on the same straight line in each graph when the points are plotted in the graph in which the length of the unit structure in the two directions is respectively the horizontal axis.

In one unit structure of the dielectric layer, the absolute value of the relative reflection phase difference of the electromagnetic waves in neighboring cell regions is less than 180°, preferably 120° or less, and more preferably 60° or less. The smaller the absolute value of the difference in the relative reflection phase of the electromagnetic waves in neighboring cell regions, the smoother the wavefront of the reflected waves. Also, the absolute value of the difference of the relative reflection phase of the electromagnetic waves in neighboring the cell regions is over 0°.

When the maximum thickness cell region having the maximum thickness in one unit structure and the minimum thickness cell region having the minimum thickness in the other unit structure are adjacent to each other in the adjacent unit structure, on the basis of reflection phase in the cell region where the delay of reflection phase in one unit structure is the smallest, when the relative reflection phase of the electromagnetic wave in the minimum thickness cell region having the minimum thickness in the other unit structure is set to be over −720° and −360° or less shifted by one, the absolute value of the difference between the relative reflection phase of the electromagnetic wave in the maximum thickness cell region having the maximum thickness in one unit structure and the relative reflection phase of the electromagnetic wave in the minimum thickness cell region having the minimum thickness in the other unit structure is less than 180°, preferably 120° or less, and more preferably 60° or less. The smaller the absolute value of the difference in the relative reflection phase of the electromagnetic waves in these neighboring cell regions, the smoother the wavefront of the reflected waves. Also, the absolute value of the difference in the relative reflection phase of electromagnetic waves in these neighboring cell regions is over 0°. For example, in FIG. 1C, in the adjacent unit structures 10a and 10b, the relative reflection phase of the electromagnetic wave in the maximum thickness cell region 11f having the maximum thickness t6 of one unit structure 10a is −300°, and the relative reflection phase of the electromagnetic wave in the minimum thickness cell region 11a having the minimum thickness t1 of the other unit structure 10b is Thus, the absolute value of a difference between the relative reflection phase of the electromagnetic waves in the maximum thickness cell region 11f having the maximum thickness t6 of one unit structure 10a and the relative reflection phase of the electromagnetic waves in the minimum thickness cell region 11a having the minimum thickness t1 of the other unit structure 10b, is 60°.

Also, in one unit structure of the dielectric layer, the difference of the relative reflection phase of the electromagnetic waves in neighboring cell regions is preferably equal. For example, as shown in FIG. 1B, if the unit structure 10 of the dielectric layer 5 includes six cell regions, each of the difference of the relative reflection phases of the electromagnetic waves in the neighboring cell regions 11a and 11b, the difference of the relative reflection phases of the electromagnetic waves in the neighboring cell regions 11b and 11c, the difference of the relative reflection phases of the electromagnetic waves in the neighboring cell regions 11c and 11d, the difference of the relative reflection phases of the electromagnetic waves in the neighboring cell regions 11d and 11e, and the difference of the relative reflection phases of the electromagnetic waves in the neighboring cell regions 11e and 11f, are preferably equal. For example, in FIG. 1C, all of the absolute values of differences in the relative reflection phases of electromagnetic waves in neighboring cell regions are 60° and equal.

In addition, when the maximum thickness cell region having the maximum thickness in one unit structure and the minimum thickness cell region having the minimum thickness in the other unit structure are adjacent to each other in the adjacent unit structure, on the basis of the reflection phase in the cell region where the delay of the reflection phase in one unit structure is the smallest, when the relative reflection phase of the electromagnetic wave in the minimum thickness cell region having the minimum thickness in the other unit structure is set to be over −720° and −360° or less shifted by one cycle, the difference in the relative reflection phases of the electromagnetic waves in neighboring cell regions are preferably equal not only in all the cell regions in one unit structure but also including the minimum thickness cell region having the minimum thickness in the other unit structure. For example, in FIG. 1C, in adjacent unit structures 10a and 10b, the relative reflection phases of electromagnetic waves in each cell region 11a to 11f of one unit structure 10a are respectively 0°, −60°, −120°, −180°, −240°, and −300°, and the relative reflection phase of electromagnetic waves in the minimum thickness cell region 11a having the minimum thickness t1 of the other unit structure 10b is −360°. Thus, in all the cell regions 11a to 11f in one unit structure 10a, and including the minimum thickness cell region 11a having the minimum thickness t1 in the other unit structure 10b, the absolute values of difference in the relative reflection phases of the electromagnetic waves in neighboring cell regions are all 60° and equal.

Also, in one unit structure of the dielectric layer, an absolute value of a difference between the relative reflection phase of the electromagnetic waves in the minimum thickness cell region having the minimum thickness, and the relative reflection phase of the electromagnetic waves in the maximum thickness cell region having the maximum thickness, is less than 360°. Also, in one unit structure of the dielectric layer, an absolute value of a difference between the relative reflection phase of the electromagnetic waves in the minimum thickness cell region having the minimum thickness, and the relative reflection phase of the electromagnetic waves in the maximum thickness cell region having the maximum thickness needs to be more than 180°, and is preferably 300° or more and less than 360°. For example, as shown in FIG. 1B, when the unit structure 10 of the dielectric layer 5 includes six cell regions, in one unit structure 10, an absolute value of a difference between the relative reflection phase of the electromagnetic waves in the minimum thickness cell region 11a having the minimum thickness t1, and the relative reflection phase of the electromagnetic waves in the maximum thickness cell region 11f having the maximum thickness t6, is preferably less than 360°. For example, in FIG. 1C, in one unit structure 10 of the dielectric layer 5, the relative reflection phase of the electromagnetic wave in the minimum thickness cell region 11a having the minimum thickness t1 is 0°, the relative reflection phase of the electromagnetic wave in the maximum thickness cell region 11f having the maximum thickness t6 is −300°, and the absolute value of the difference between the relative reflection phase of the electromagnetic wave in the minimum thickness cell region 11a having the minimum thickness t1 and the relative reflection phase of the electromagnetic wave in the maximum thickness cell region 11f having the maximum thickness t6 is 300°.

The size of the unit structure of the dielectric layer, specifically the length of the unit structure in a predetermined direction in which the thickness increases, is appropriately set according to the target reflection properties. The length of the unit structure in a predetermined direction in which the thickness increases allows the reflection angle to be adjusted because the one wavelength or phase will be shifted by 360°. For example, by shortening the length of the unit structure in a predetermined direction in which the thickness increases, the difference in reflection angle with respect to the regular reflection angle can be increased. On the other hand, by increasing the length of the unit structure in a predetermined direction in which the thickness increases, the difference in the reflection angle with respect to the regular reflection angle can be reduced.

Also, the cross-sectional shape of the unit structure of the dielectric layer may be, for example, a stepped shape in which the thickness stepwisely increases in a predetermined direction, or a tapered shape in which the thickness gradually increases in a predetermined direction. For example, FIG. 1B is an example in which the unit structure 10 of the dielectric layer 5 has a stepped shape, and FIG. 5 is an example in which the unit structure 10 of the dielectric layer 5 has a tapered shape.

The unit structure of the dielectric layer includes a plurality of cell regions having different thicknesses, but if the cross-sectional shape of the unit structure of the dielectric layer has a tapered shape, the number of cell regions in the unit structure can be considered to be infinite. In this case, the thickness distribution of the unit structure is designed so that the relative reflection phase of the electromagnetic wave in each cell region is set as described above.

Further, since the dielectric layer includes a plurality of unit structures including a thickness distribution, the pattern shape in a planar view of the unit structure may be a shape that can be arranged without a gap, and examples of the shape may include a rectangular shape, a regular hexagon shape. For example, FIGS. 3A to 3F and 4A are examples in which the pattern shape in the planar view of the unit structure 10 of the dielectric layer is rectangular.

In the unit structure of the dielectric layer, the difference in the round-trip optical path lengths in neighboring cell regions is designed such that the relative reflection phase of the electromagnetic waves in each cell region is set as described above. The thickness of each cell region is set such that the difference in thickness of neighboring cell regions is the difference in the round-trip optical path lengths in the neighboring cell regions described above. The thickness of each cell region is appropriately set according to the wavelength of the electromagnetic wave, the dielectric constant of the material of the dielectric layer, and the intended reflection properties. For example, if the effective wavelength of the electromagnetic wave passing through the dielectric layer is λ_{g} and the thickness of the base is α, the thickness of each cell region is preferably about α+0λ_{g} or more and α+2λ_{g} or less. The thickness α of the base may be the same as the minimum thickness of the minimum thickness cell region having the minimum thickness in one unit structure of the dielectric layer. Although the thickness α of the base is appropriately set in consideration of the overall strength, ease of formation, etc., it is preferable that the thickness a of the base is typically about 0.1λ_{g} or less, in view of the influence to the electromagnetic waves. Specifically, when the wavelength λ₀ in the air of the electromagnetic wave is 10 mm and the dielectric constant of the dielectric layer is 2.57, the thickness of each cell region is preferably 0 mm or more and 8.6 mm or less. When the thickness of the cell region is 0 mm, it means that the cell region located on the reflecting member is not formed with a dielectric layer.

Further, in the unit structure of the dielectric layer, the difference between the minimum thickness and the maximum thickness is, for example, preferably 0.2 mm or more and 15 mm or less, and more preferably 2.1 mm or more and 10.4 mm or less.

Here, the effective wavelength λ_{g} of the electromagnetic wave propagating in the dielectric layer is represented by λ_{g}=λ₀/√ε, where λ₀ is the wavelength in the free space corresponding to the frequency f of the particular electromagnetic wave and c is the relative dielectric constant of the dielectric layer. Thus, as described above, if the thickness of each cell region is, for example, about α+0λ_{g} or more and α+2λ_{g} or less, when the dielectric constant of the dielectric layer is low, the thickness of each cell region becomes thicker, and when the dielectric constant of the dielectric layer is high, the thickness of each cell region becomes thinner. Thus, when the dielectric constant of the dielectric layer is low, the difference between the minimum thickness and the maximum thickness tends to increase, and if the dielectric constant of the dielectric layer is high, the difference between the minimum thickness and the maximum thickness tends to decrease.

If the difference between the minimum thickness and the maximum thickness is too large, the overall thickness of the frequency selective reflector may be increased, resulting in constraints on the installation, which can lead to poor handling. There is also a risk of increasing manufacturing costs. On the other hand, to reduce the difference between the minimum thickness and the maximum thickness, it is necessary to increase the dielectric constant of the dielectric layer, as described above. However, there is a tendency the higher the dielectric constant of the dielectric layer, the greater the dielectric loss and the greater the reflection at the dielectric interface. As a result, reflection to the designed direction is reduced. Thus, if the difference between the minimum thickness and the maximum thickness is too small, there is a risk that losses including dielectric loss and interfacial reflections may be increased.

Note that the minimum thickness and maximum thickness in the unit structure of the dielectric layer refer to the minimum thickness and maximum thickness throughout one unit structure of the dielectric layer. For example, as shown in FIG. 1B, if the unit structure 10 of the dielectric layer 5 includes six cell regions 11a to 11f, the minimum thickness is t1 and the maximum thickness is t6. Also, for example, as shown in FIG. 5, when the unit structure 10 of the dielectric layer 5 has a tapered shape, the minimum thickness is to and the maximum thickness is tb.

The difference between the minimum thickness and the maximum thickness in the unit structure of the dielectric layer is, for example, a value measured using a thickness measurement technique having a thickness resolution of about 1 μm. Also, for example, as the difference between the minimum thickness and the maximum thickness, a value measured by observing the cross-section in the thickness direction of the unit structure of the dielectric layer with an optical microscope may be used.

In the unit structure of the dielectric layer, the pitch and width of the cell region are appropriately set.

Also, when the reflecting member is a member in which a plurality of reflective elements is arranged, the pitch of the cell region of the unit structure of the dielectric layer may be the same as or different from the pitch of the reflective element of the reflecting member. If the pitch of the cell region of the unit structure of the dielectric layer is the same as the pitch of the reflective element of the reflecting member, the designing is easy. Also, for example, by narrowing the pitch of the cell region of the unit structure of the dielectric layer while keeping the difference in the relative reflection phase of the electromagnetic wave in the neighboring cell regions, the control region of the reflection properties can be widened regardless of the pitch of the reflective element of the reflecting member.

Also, in one unit structure of the dielectric layer, the pitch of the cell regions is preferably equal.

The pitch of the cell region refers to the distance from the center of one cell region to the center of the neighboring cell region.

Also, in one unit structure of the dielectric layer, the width of the cell regions in a predetermined direction in which the thickness increases, is preferably equal.

In the unit structure of the dielectric layer, the pattern shape of the cell region in plan view includes, for example, a stripe shape, one shape of the concentric square divided into four equal parts by straight lines perpendicular to each other and parallel to the sides, a microarray shape, a concentric quadrant, which is one shape of a concentric circle divided into four equal parts by diameter perpendicular to each other, a curved stepped shape, or the like. FIG. 3B is an example of the stripe shape. FIG. 3D is an example of one shape of the concentric square divided into four equal parts by straight lines perpendicular to each other and parallel to the sides. FIG. 3F and FIG. 4A are examples of the microarray shape. FIG. 4B is an example of the concentric quadrant. FIG. 4C is an example of the curved stepped shape. FIG. 3B is a top view of FIG. 3A. FIG. 3D is a top view of FIG. 3C. FIG. 3F is a top view of FIG. 3E. Further, when these illustrated unit structures are arranged without gaps, there is no particular restriction in the direction of the arrangement; for example, a rectangular unit structure may be arranged on the entire surface in a state of being rotated clockwise by 30 degrees in a plan view, and the unit structure may be selected and arranged at an appropriate angle and an appropriate arrangement direction according to the required reflection properties' design.

The unit structure of the dielectric layer includes a plurality of cell regions. In one unit structure of the dielectric layer, the number of cell regions is, for example, 3 or more and may be 6 or more. The greater the number of cell regions in one unit structure of the dielectric layer, the smaller the difference in the relative reflection phase of the electromagnetic waves in neighboring cell regions, and the wavefront of the reflected waves can be smoothed. Also, the upper limit is not particularly limited for the number of cell regions in one unit structure of the dielectric layer. When the cross-sectional shape of the unit structure is stepped shape, the number of cell regions corresponds to the number of steps in the stepped shape. Also, when the cross-sectional shape of the unit structure is tapered shape, the tapered shape can be regarded as having an infinite number of cell regions, as described above.

The dielectric layer includes, as the unit structure, at least a first unit structure including three or more cell regions of which thickness differs from one another.

Also, the dielectric layer may include only the first unit structure as the unit structure, and may further include a second unit structure different from the first unit structure. In other words, the dielectric layer may include only the same unit structure as the unit structure and may include different unit structures. If the dielectric layer is one in which a plurality of different unit structures is arranged, the total reflection properties of the frequency selective reflector can be influenced. Specifically, the adjustment of polarization characteristics, the effect on the beam profile, and the like are to be influenced. The influence on the beam profile refers to, for example, to be a highly directional beam, a diffusive beam, and a multi-beam, etc.

The first unit structure and the second unit structure may have different reflection properties from each other. For example, at least one of the length of the unit structure in the direction in which the thickness increases, the thickness distribution, the number of cell regions, the width of the cell region, the pitch of the cell region, the pattern shape in the plan view of the unit structure, and the pattern shape in the plan view of the cell region may be different.

Also, when the dielectric layer includes unit structures different from each other as the unit structure, the number of types of unit structures is not particularly limited.

In the dielectric layer, the thickness distribution of the dielectric layer is appropriately selected so that the normal vector of the same phase surface of the reflected wave with respect to the incident wave incident at a predetermined incident angle is in a desired reflection direction, and the plurality of unit structures is arranged. For example, when the incident wave is reflected as a so-called plane wave which reflects the incident wave to a single direction, it is preferable that the dielectric layer includes a plurality of only the same unit structure arranged therein, the length of the unit structure in the direction in which the thickness increases is the same, and the pattern shape in the planar view of the cell region is more preferably striped. For example, in FIGS. 1A to 1C, the dielectric layer 5 includes a plurality of only the same unit structure, the length L of the unit structures 10a and 10b in the predetermined direction D1 is the same, and the pattern shape of the cell regions 11a to 11f in plan view is striped. In this case, as exemplified in FIG. 2, the incident wave W1 incident at a predetermined incident angle θ1 can be reflected at a single reflection angle θ2, and the reflected wave W2 can be a plane wave that does not spread. Also, although FIG. 1A shows an arrangement in which the longitudinal direction of the stripes of the cell region is parallel to the shorter direction of the wavelength selective reflector, but the arrangement is not limited thereto in an actual wavelength selective reflector, and the longitudinal and shorter directions of the stripes of the cell region can be arbitrarily set according to the design of the reflection properties.

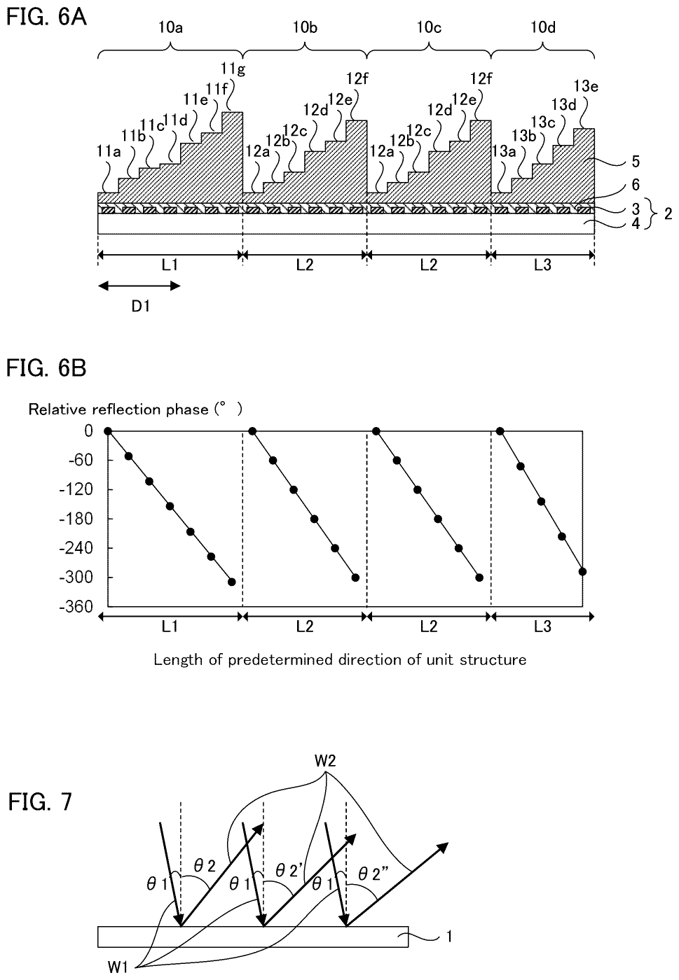

Also, for example, when spreading the electromagnetic waves, that is when reflected as a cylindrical wave, examples of the aspect of the dielectric layer is preferably the one that includes a plurality of mutually different unit structures arranged therein, the length of the unit structure in the direction in which the thickness increases is different, and the pattern shape in the planar view of the cell region is striped. For example, in FIG. 6A, the dielectric layer 5 includes three types of unit structures 10a, 10b, 10c, and 10d different from each other. In the unit structures 10a, 10b, 10c and 10d, the length L1, L2, and L3 of the unit structure in the predetermined direction D1 are different from each other, and the number of cell regions 11a to 11g, 12a to 12f, and 13a to 13e are different from each other. Thus, as shown in FIG. 6B, the relative reflection phases of the electromagnetic waves in each cell region 11a to 11g of the unit structure 10a are 0°, −51.4°, −103°, −154°, −206°, −257°, −309°, respectively; the relative reflection phases of the electromagnetic waves in each cell regions 12a to 12f of the unit structures 10b and 10c are 0°, −60°, −120°, −180°, −240°, −300°, respectively; the relative reflection phases of the electromagnetic waves in each cell regions 13a to 13e of the unit structure 10d are 0°, −72°, −144°, −216°, −288°, respectively; and the unit structures 10a, 10b, 10c and 10d have different reflection properties. Also, although not illustrated, the pattern shapes in the planner view of the cell regions 11a to 11g, 12a to 12f, and 13a to 13e are striped. In this case, as exemplified in FIG. 7, the incident wave W1 incident at a predetermined incident angle θ1 can be reflected at the reflection angles θ2, θ2′, and θ2″ depending on the unit structures, can be reflected with a spread, and the wavefront of the reflected wave W2 can be widened.

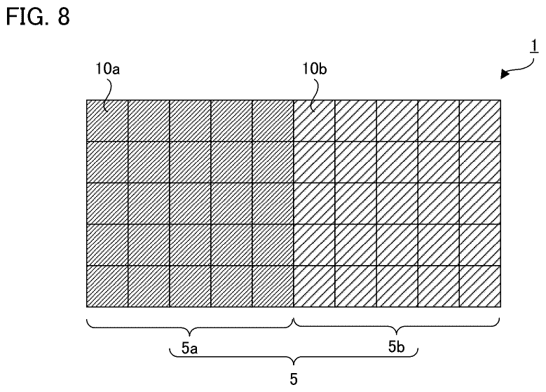

Further, when the dielectric layer includes unit structures different from each other as the unit structure, a plurality of types of unit structures having mutually different reflection properties may be used, a plurality of unit structures may be arranged for each type, and a region in which the plurality of unit structures of the same type is arranged may be arranged in a plane. For example, in FIG. 8, two types of unit structures 10a and 10b including different reflection properties are used to form a dielectric layer 5, in which a first region 5a where a plurality of unit structures 10a of one type is arranged and a second region 5b where a plurality of unit structures 10b of the other type is arranged, are arranged in a plane. In such an aspect, a plurality of coverage holes may be associated.

Further, for example, when the reflecting member described below is a frequency selective plate and includes a plurality of kinds of frequency selective surfaces for selectively reflecting electromagnetic waves in mutually different frequency bands, the reflection properties of the unit structures may be respectively designed according to the frequency selectivity of the frequency selective surfaces, and the dielectric layer may include unit structures including different reflection properties as the unit structure. In this case also, for example, it can be arranged as shown in FIG. 8. In such an aspect, the dual band or more of the bands can be corresponded.

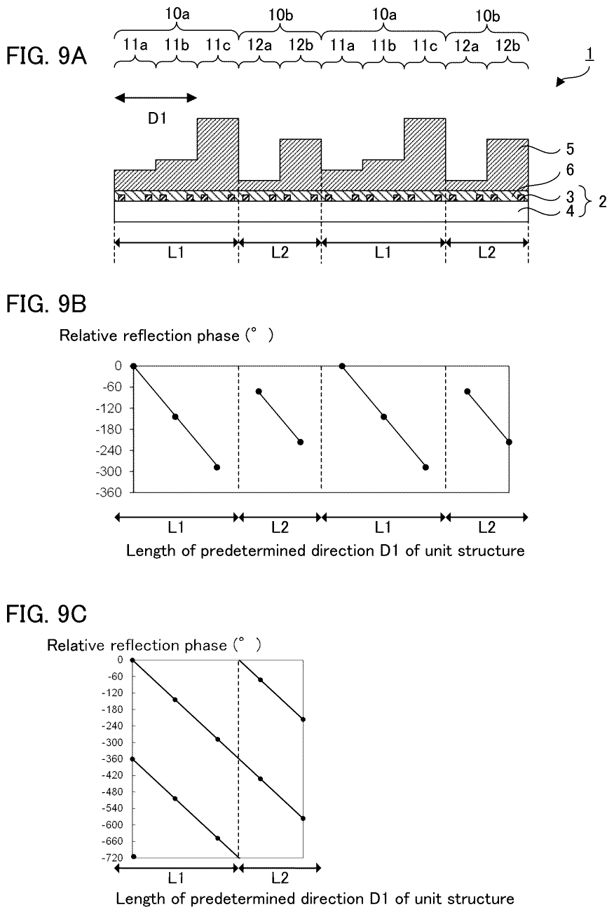

Also, when the dielectric layer includes unit structures different from each other as the unit structure, for example, the relative reflection phase of the electromagnetic waves in each cell region of n pieces of unit structures may be set so as to be shifted by n wavelengths by the n pieces of unit structures. In this case, the phase difference is n*360°. Note that n is an integer greater than or equal to 2. For example, FIGS. 9A to 9C are examples in which the dielectric layer 5 includes two types of unit structures 10a and 10b different from each other, and the relative reflection phases of the electromagnetic waves in the cell regions 11a to 11c, 12a to 12b of the two unit structures 10a and 10b are set so as to be shifted by two wavelengths by the two unit structures 10a and 10b. In this case, the phase difference is 720°. FIG. 9B is a graph in which the range of the relative reflection phase of the electromagnetic wave is denoted as over −360° and 0° or less, and FIG. 9C is a graph in which the range of the relative reflection phase of the electromagnetic wave is over −720° and 0° or less, and a point that the substantially the same phase of the relative reflection phase shifted by 360° is complimented. In these unit structures 10a and 10b, the length L1 and L2 of the unit structure in a predetermined direction D1 are different from each other, and the number of cell regions 11a to 11c, 12a to 12b are different from each other.

In the above case, one unit structure 10a includes three cell regions 11a to 11c, while the other unit structure 10b includes two cell regions 12a and 12b. In this manner, when the dielectric layer includes unit structures different from each other as the unit structure, at least one unit structure may include three or more cell regions including different thicknesses, and in other types of unit structures, the number of cell regions may not be three or more, but may be two.

When the incident wave and the reflected wave are plane waves, the dielectric layer includes a periodic structure in which the unit structure is repeatedly arranged. The term “periodic structure” refers to a structure in which a unit structure is periodically repeatedly arranged. In the unit structure in the periodic structure, in the unit structure having the same reflection properties, the length of the unit structure in the direction in which the thickness increases, the thickness distribution, the number of cell regions, the width of cell region, the pitch of cell region, the pattern shape in the plan view of the unit structure, the pattern shape in the plan view of the cell region, and the like can be made the same. Also, in the case where the dielectric layer has a periodic structure, the unit structures including different reflection properties can be combined as described above. In that case, the reflection properties of the unit structure to be combined are appropriately designed according to the target reflection properties, and specifically, the length of the unit structure in a direction in which the thickness increases, thickness distribution, the number of cell regions, the width of cell region, the pitch of cell region, the pattern shape of the unit structure in plan view, the pattern shape of the cell region in plan view, etc. in the unit structure to be combined are appropriately set according to the target reflection properties.

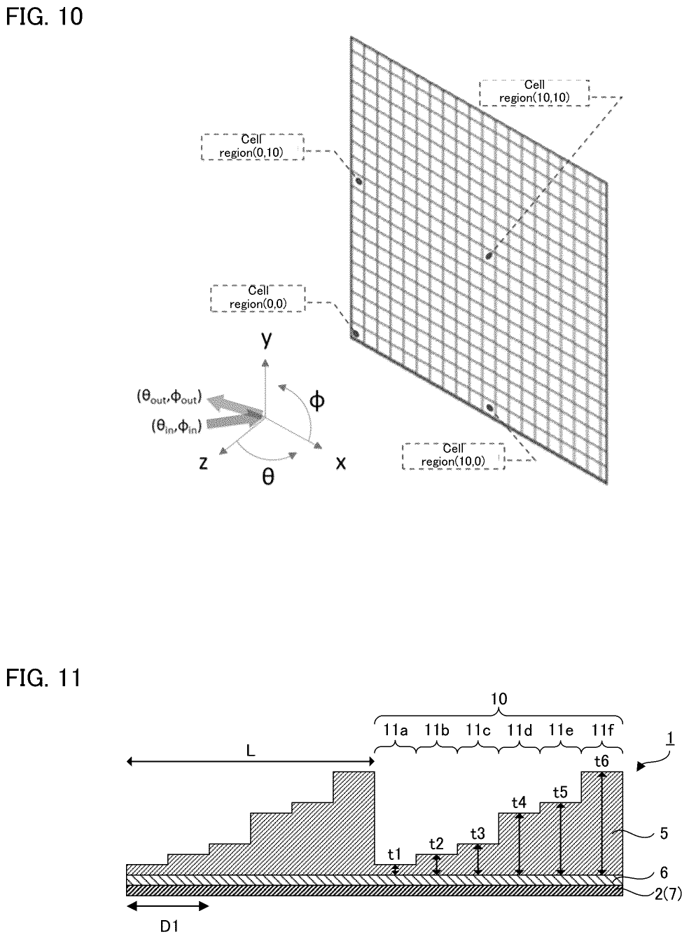

In general, a reflective characteristic design in which a plane wave is reflected as a plane wave to a direction different from the regular reflection direction, for example, can be designed by, after resolving into incident and reflection properties as the in-plane x-direction and in-plane y-direction of the reflective plate, converting them to a reflective phase distribution in the x-direction and the y-direction, and incorporating them as the thickness distribution of the unit structure. For example, as shown in FIG. 10, a part of the frequency selective reflector in which a cell region of the same size capable of individually adjusting a reflection phase is arranged to 10*10 (i=10, j=10), is described as an example. It should be noted that at this time, the magnitude of 10*10 of the cell region is not necessarily the size of the unit structure. The reflection phase δ_{i,j} determined in the cell region of the (i,j) position when the plane wave incident from the direction of the incident angle (θᵢₙ, φᵢₙ) is reflected by the plane wave in the direction of the reflection angle (θₒᵤₜ, φₒᵤₜ) is given by following equation.

δ_{i,j}2π{p*i*(sin θₒᵤₜ*cos φₒᵤₜ−sin θᵢₙ*cos φᵢₙ)+p*j*(sin θₒᵤₜ*sin φₒᵤₜ−sin θᵢₙ*sin φᵢₙ)}/λ

Here, in the above equation, symbols indicated are:
δ_{i,j}: the reflection phase of the cell region in the (i,j) position with respect to phase center (0, 0)
λ: wavelength [m] of the reflected wave
p: size of the cell region [m]
θᵢₙ: θ slope of incident wave
φᵢₙ: φ slope of incident wave
θₒᵤₜ: θ slope of reflected wave
φₒᵤₜ: φ slope of reflected wave.

The dielectric layer may be, for example, a single layer or multiple layers. The dielectric layer may also include a substrate portion that can be a base and a concave and convex portion disposed on the substrate portion. Also, for example, the dielectric layer may be a single member in which all cell regions are integrally formed, and may be one in which the individual cell regions are formed separately, and the block-like cell regions are arranged.

(2) Properties of the Dielectric Layer

The dielectric layer transmits electromagnetic waves in a particular frequency band and may or may not transmit electromagnetic waves in other frequency bands.

The dielectric loss tangent of the dielectric layer is preferably relatively small. The low dielectric loss tangent of the dielectric layer can reduce dielectric loss and reduce high frequency losses. Specifically, the dielectric loss tangent of the dielectric layer with respect to the electromagnetic wave of the target frequency is preferably 0.01 or less. Also, the dielectric loss tangent of the dielectric layer is the smaller the more preferable, and the lower limit value is not particularly limited.

Also, the dielectric constant of the dielectric layer is preferably relatively high. With the high dielectric constant of the dielectric layer, the effect of reducing the thickness of the dielectric layer can be expected. Specifically, the dielectric constant of the dielectric layer in the electromagnetic wave of the target frequency is preferably 2 or more, more preferably 2.5 or more, and further more preferably 3 or more when the difference in the reflection angle with respect to the regular reflection angle is increased.

Here, the dielectric loss tangent and the dielectric constant of the dielectric layer can be measured by a resonator method.

(3) Material of Dielectric Layer

The material of the dielectric layer is not particularly limited if it is a dielectric capable of transmitting a predetermined electromagnetic wave, and for example, a resin, glass, quartz, ceramics, or the like can be used. In view of the ease of forming the concave and convex structure, the resin is suitable among them.

Although the resin is not particularly limited if it is capable of transmitting a predetermined electromagnetic wave, it is preferably the one that absorption of the electromagnetic wave is relatively low and the transmittance of the electromagnetic wave is relatively high. Also, the resin preferably satisfies the aforementioned dielectric loss tangent, and more preferably satisfies the aforementioned dielectric constant. Such resins may include, for example, polycarbonates, acrylic resins, ABS resins, PLA resins, olefinic resins, copolymers thereof, and the like. In particular, the polycarbonate is suitable since it is excellent in dimensional stability and low in high frequency loss.

Also, the dielectric layer may further contain a filler. The dielectric layer may contain a filler to adjust the dielectric constant and mechanical strength of the dielectric layer. The dielectric constant of the filler is preferably higher than the dielectric constant of the resin. This can increase the dielectric constant of the dielectric layer and reduce the thickness of the required dielectric layer. The high dielectric constant filler is not particularly limited, and examples thereof may include inorganic particles such as glass, silica, barium titanate; and fine fibers.

The filler material, shape, size, and content may be appropriately chosen from the desired dielectric constant, mechanical strength, and difficulty of dispersibility, etc. The size of the filler needs to be sufficiently smaller than the wavelength of the electromagnetic wave of interest, and if the effective wavelength of the electromagnetic wave is λ_{g}, the diameter of the filler sphere is preferably 0.01λ_{g} or less. However, it tends to be difficult to uniformly disperse as the size of the filler approaches the nanometer order, the load of the processing process may increase. In addition, the content of the filler in the dielectric layer varies depending on the combination of the material of the dielectric and the filler, the shape of the filler, the size of the filler, and the like, and is appropriately adjusted.

When the concave and convex structure of the dielectric layer is formed by molding or the like using a mold, for example, a release agent, an antistatic agent, or the like may be added to the dielectric layer. These can be used as appropriately selected from those generally used. In addition, it is preferable that the dielectric layer does not contain additives or fillers such as carbon black and metal particles that impart electrical conductivity.

(4) Method for Forming Dielectric Layer

The method for forming the dielectric layer is not particularly limited if a predetermined concave and convex structure can be formed, and examples thereof may include cutting a resin sheet, laser processing, using a mold and vacuum casting, a 3D printer, and joining small piece parts. In the case of a forming method that does not use a mold, such as cutting, laser processing, and 3D printers, since customization according to the target reflection angle is easy, In the case of using a mold, it may be shaped on a substrate made of a dielectric, where the substrate and the shaped resin in this case may be materials that are different from each other if they are materials that transmit a predetermined electromagnetic wave. Also, for example, in the case of designing and manufacturing the reflecting member and the dielectric layer separately, by preparing a plurality of types of dielectric layers having reflection properties to have a predetermined incident angle and reflection angle in advance, selecting the type of the dielectric layer according to the situation, and rotating the dielectric layer in the plane with the normal direction as an axis with respect to the reflecting member, when a fine adjustment of the reflection direction of the electromagnetic wave is performed, the dielectric layer of the same specification can be made more cost effectively, and in that case, the method of using a mold is suitable.

2. Reflecting Member

The reflecting member in the present embodiment is a member that reflects electromagnetic waves in a particular frequency band.

The reflecting member is not particularly limited if it reflects electromagnetic waves in a particular frequency band, and for example, it may reflect only electromagnetic waves in a particular frequency band, or it may reflect not only electromagnetic waves in a particular frequency band but also electromagnetic waves in other frequency bands. In particular, the reflecting member preferably includes a wavelength selecting function that reflects only electromagnetic waves in a particular frequency band.

The reflecting member that reflects electromagnetic waves in a particular frequency band as well as other frequency bands may include, for example, a reflective layer disposed on the entire surface of the frequency selective reflector. For example, FIG. 11 is an example in which the reflecting member 2 is a reflective layer 7. In FIG. 11, the reflective layer 7 is disposed on the entire surface of the frequency selective reflector 1.

The material of the reflective layer is not particularly limited if it is a material capable of reflecting electromagnetic waves in a particular frequency band, and examples thereof may include a conductive material such as a metal material, carbon, and ITO.

The thickness of the reflective layer is not particularly limited if a thickness is capable of reflecting electromagnetic waves in a particular frequency band, and it is appropriately set.

In addition, the reflecting member that reflects only a particular frequency band may be the one that includes a wavelength selecting function that reflects only electromagnetic waves in a particular frequency band. The reflecting member may be a frequency selective plate.

The frequency selective plate includes a frequency selective surface that controls reflection and transmission to electromagnetic waves in a particular frequency band. The frequency selective surface is also referred to as an FSS or Frequency Selective Surface. When functioning as a reflector to electromagnetic waves in a particular frequency band, the frequency selective plate may include a plurality of reflective or scattering elements arranged in a plane. The frequency selective plate may include, for example, a dielectric substrate and a plurality of reflective elements arranged on a dielectric layer-side surface of the dielectric substrate. FIG. 1B is an example in which the reflecting member 2 is a frequency selective plate, and the reflecting member 2 includes a dielectric substrate 4 and a plurality of reflective elements 3 arranged on a surface of the dielectric substrate 4 that is the dielectric layer 5 side. The frequency selective plate may be appropriately selected from conventionally known frequency selective plates.

Examples of the shape of the reflective element forming the frequency selective surface may include any shapes. The shape of the reflective element forming the frequency selective surface may be a planar pattern shape. The planar pattern shape may be, for example, a ring shape, a cross shape, a square shape, a rectangular shape, a circular shape, an elliptical shape, a rod shape, a pattern shape divided into a plurality of adjacent regions, or the like. The shape of the reflective element forming the frequency selective surface may also be a three-dimensional shape. The three-dimensional shape may be a through-hole via or the like.

The reflective element may be, for example, a single layer or multiple layers. If the reflective element is a single layer, the frequency selective plate may be, for example, the one in which a plurality of reflective elements is arranged on one side of the dielectric substrate. When the reflective element is multiple layers, for example, the frequency selective plate may be one in which a plurality of reflective elements is arranged on both surfaces of the dielectric substrate, one in which a dielectric substrate, a plurality of reflective elements, a dielectric substrate, and a plurality of reflective elements are arranged in the order, and one in which a conductor is disposed on entire surface of the surface farthest from the surface of the incident side of the electromagnetic wave, or the like.

The frequency reflective plate, that is, the reflecting member preferably includes a reflection phase control function controlling a reflection phase of the electromagnetic waves. The reflecting member may include reflective elements of which one or both of the sizes and shapes are varied. The variation in the sizes of the reflective element may be gradually reduced or expanded. By varying the size and shape of the reflective element, the resonant frequency can be varied per reflective element, and the reflection phase of the electromagnetic wave can be controlled. Therefore, when the frequency selective plate has a reflection phase control function, the reflection properties of the electromagnetic wave can be controlled by controlling the reflection phase distribution of the electromagnetic wave by the thickness of the dielectric layer and the size and shape of the reflective element. Thus, for example, the reflection properties in two orthogonal directions in the plane of the frequency selective reflector can be individually designed with the frequency selective plate and the dielectric layer, and the reflection properties of the desired electromagnetic wave can be obtained while suppressing the thickness of the dielectric layer. The two orthogonal directions may be, for example, an x-axis direction and a y-axis direction.

General frequency selective surfaces may be applied as a frequency selective plate having a reflection phase control function. Although these have advantages and disadvantages in the design, it is possible to vary the reflection phase of the electromagnetic wave by varying the size and shape of the reflective element.

The different sizes of the reflective element are appropriately selected depending on the shape of the reflective element.

3. Control of Reflection Direction of Electromagnetic Waves

In the frequency selective reflector of the present embodiment, by varying the thickness of each cell region of the unit structure of the dielectric layer, the reciprocal optical path length in the dielectric layer can be varied per cell region, and the relative reflection phase of the electromagnetic wave can be controlled. Thereby, by adjusting the size and the plan view pattern of the unit structure of the dielectric layer as well as the number and thickness of the cell regions of the unit structure of the dielectric layer, the reflection direction of the electromagnetic wave incident from the predetermined direction can be controlled.

In addition, when the reflecting member is a frequency selective plate and is a member having a reflection phase control function, by varying the thickness of each cell region of the unit structure of the dielectric layer, the round-trip optical path length in the dielectric layer can be varied per cell region, and also, by varying the size and shape of the reflective element of the reflecting member, the resonance frequency per reflective element can be varied to control the reflection phase of the electromagnetic wave; thereby, the degree of freedom of design related to the reflection characteristic control can be increased.

In this case, it is also possible to divide the reflection control direction in the reflecting member and the reflection control direction in the dielectric layer, and perform two-dimensional reflection direction control in the entire frequency selective reflector. Also, when the reflection control directions in the reflecting member and the dielectric layer are overlapped, for example, a reflection phase distribution to be reflected in a certain direction to some degree can be achieved by the reflecting member, and further fine adjustment can be performed in the dielectric layer. In this case, there is an advantage that the thickness of the dielectric layer can be reduced.

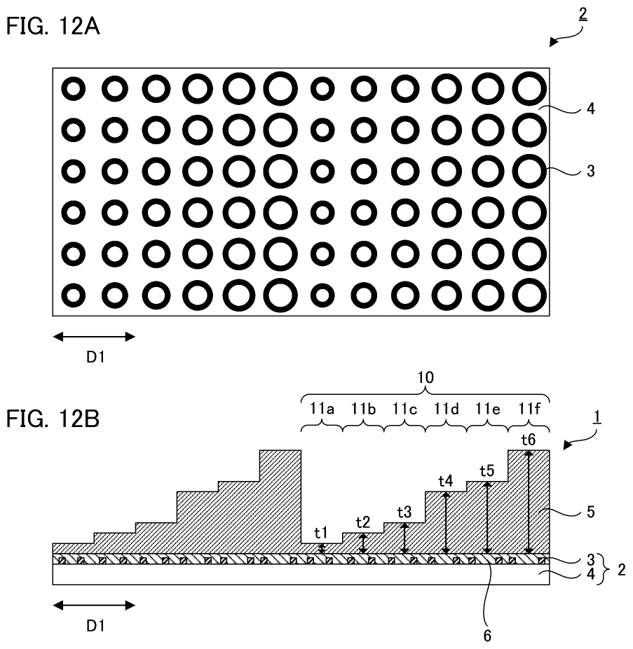

As the arrangement of the thickness distribution of the dielectric layer and the size distribution of the reflective element of the reflecting member, for example, as shown in FIG. 12, the dielectric layer 5 and the reflecting member 2 can be arranged so that the thickness of the cell regions 11a to 11f of the unit structure 10 of the dielectric layer 5 becomes thicker as the size of the reflective element 3 of the reflecting member 2 increases. In such an aspect, the thickness of the dielectric layer can be reduced. This makes it possible to reduce the weight and cost of the frequency selective reflector because the dielectric layer is thin, and to make the reflected wave less likely to hit the dielectric layer even when the reflection angle increases.

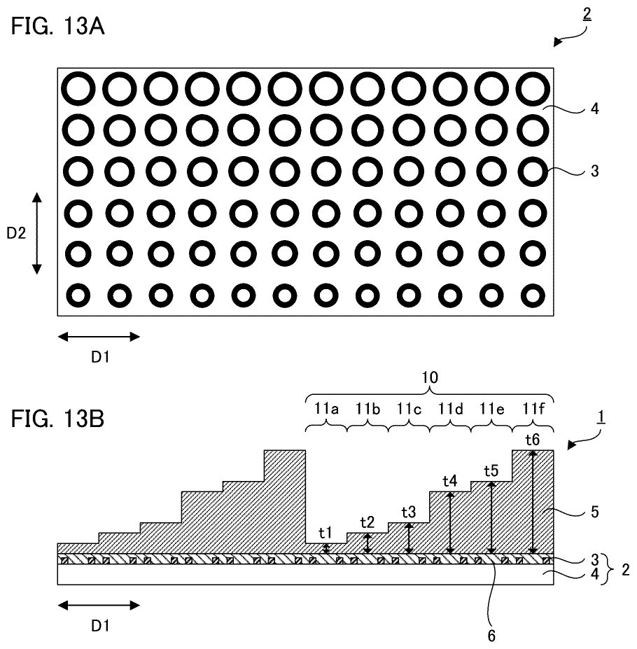

As an arrangement of the thickness distribution of the dielectric layer and the size distribution of the reflective element of the reflecting member, for example, as shown in FIG. 13, the dielectric layer 5 and the reflecting member 2 may be arranged such that the size of the reflective element 3 of the reflecting member 2 is increased along the direction D2, and the thickness of the cell regions 11a to 11f of the unit structure 10 of the dielectric layer 5 becomes thicker along a direction D1 perpendicular to the direction D2.

Incidentally, in FIG. 13, since the sizes of the reflective element are different in one cell region, the relative reflection phase of the electromagnetic wave in one cell region is partially different according to the sizes of the reflective element. Even in such a case, when cut out in a predetermined direction D1 in which the thickness increases, each point is on the same straight line in the graph described above.

Also, in the case of a specification in which the reflecting member and the dielectric layer are separately designed and combined, the reflection direction of the electromagnetic wave can be finely adjusted by rotating the dielectric layer in the plane with the normal direction as an axis with respect to the reflecting member to adjust the orientation of the cell region of the unit structure of the dielectric layer relative to the reflecting member.

Also, as described above, in the unit structure of the dielectric layer, the reflection properties can be controlled by adjusting the length of the unit structure in a predetermined direction in which the thickness increases. For example, by shortening the length of the unit structure in a predetermined direction in which the thickness increases, the reflection angle of the electromagnetic wave can be increased, while the reflection angle of the electromagnetic wave can be reduced by increasing the length of the unit structure in a predetermined direction in which the thickness increases.

The length of the unit structure in a predetermined direction in which the thickness increases in the unit structure of the dielectric layer refers to the length of the unit structure in the predetermined direction when the unit structure of the dielectric layer includes a thickness distribution in which the thickness increases in the predetermined direction. For example, in FIG. 11, in the unit structure 10 of the dielectric layer 5, the thickness increases in a predetermined direction D1, and the length of the unit structure 10 in this predetermined direction D1 is L.

Incidentally, as described above, the in-plane arrangement of the concave and convex structure of the dielectric layer that achieves the in-plane distribution design of the reflection phase in the frequency selective reflector does not need to be in a fixed positional relationship with respect to the in-plane arrangement of the reflective element of the reflecting member, and even if the concave and convex structure of the dielectric layer is shifted and arranged relative to the in-plane arrangement of the reflective element, there is no significant effect on the reflection properties. Thus, when the reflecting member is a frequency selective plate and is a member having a reflection phase control function, it is possible to independently design the dielectric layer and the reflecting member, respectively.

4. Other Configurations

The frequency selective reflector of the present embodiment may include other configurations as required in addition to the reflecting member and the dielectric layer described above.

(1) Adhesive Layer

The frequency selective reflector of the present disclosure may include an adhesive layer between the reflecting member and the dielectric layer. The adhesive layer may bond the reflecting member and the dielectric layer. Further, when the reflecting member is a member in which a plurality of reflective elements arranged, the adhesive layer may flatten the unevenness of the reflective element, and may suppress the influence of unevenness caused by the reflective element when the dielectric layer is laminated on the reflecting member. For example, in FIG. 1B, an adhesive layer 6 is disposed between the reflecting member 2 and the dielectric layer 5.

The adhesive layer may be, for example, an adhesive agent or a pressure-sensitive adhesive agent, and may be appropriately selected from known adhesive agents and pressure-sensitive adhesive agents. In that case, the adhesive agent or the pressure-sensitive adhesive agent needs to be a non-conductor. In addition, when the adhesive agent or the pressure-sensitive adhesive agent is in a liquid state, it is preferable that the one can be uniformly spread and have a fluidity to the extent capable of removing the biting of bubbles. In addition, when the adhesive agent or the pressure-sensitive adhesive agent is in the form of a sheet, the thickness is preferably uniform, and it is preferable to have flexibility to the extent capable of following the unevenness of the bonding interface and suppressing the biting of bubbles.

The thickness of the adhesive layer is preferably uniform and in thickness to provide the desired adhesive force. Also, when the reflecting member is a member in which a plurality of reflective elements arranged, the thickness of the adhesive layer is preferably equal to or greater than the thickness of the reflective element from the point of planarization. In this case, when the adhesive layer is thicker than the thickness of the reflective element, the reflective element is embedded in the adhesive layer. Preferably, the thickness of the adhesive layer is sufficiently smaller than the effective wavelength of the target electromagnetic wave, and when the effective wavelength of the electromagnetic wave is λ_{g}, specifically, it is preferably 0.01λ_{g} or less.

(2) Space

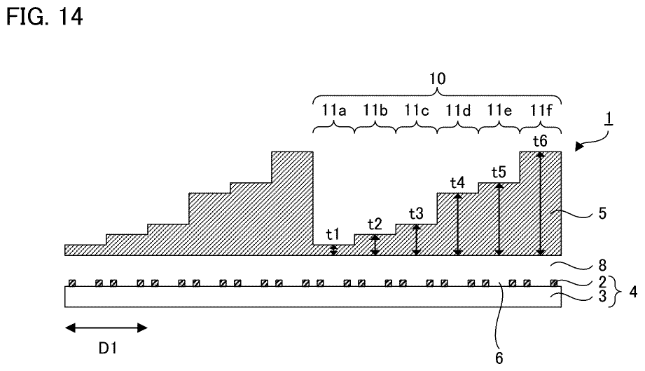

The frequency selective reflector of the present disclosure may include a space between the reflecting member and the dielectric layer. For example, in FIG. 14, a space 8 is arranged between the reflecting member 2 and the dielectric layer 5.

When a space is arranged between the reflecting member and the dielectric layer, the distance between the reflecting member and the dielectric layer is preferably constant. This makes it possible to align the optical path lengths in the space.

(3) Cover Member

The frequency selective reflector of the present disclosure may include a cover member on a surface of the dielectric layer that is opposite to the reflecting member. The cover member can protect the dielectric layer. Design can also be imparted by the cover member.

(4) Ground Layer

The frequency selective reflector of the present disclosure may include a ground layer on a surface of the reflecting member that is opposite to the dielectric layer. The ground layer can block interference with objects present on the backside of the frequency selective reflector and suppress the occurrence of noise. The ground layer may also be a part of the reflecting member that does not have wavelength selectivity. The ground layer may be the one that is conductive, and for example, a common conductive layer such as a metal plate, a metal layer, a metal mesh, carbon, an ITO film, or the like can be used.

(5) Planarizing Layer

The frequency selective reflector of the present disclosure may include a planarizing layer between the reflecting member and the dielectric layer. When the reflecting member is a member in which a plurality of reflective elements arranged, the planarizing layer can flatten the unevenness of the reflective elements, and can suppress the influence of the unevenness due to the reflective elements when the dielectric layer is laminated on the reflecting member. It should be noted that the planarizing layer referred to herein is the one disposed separately from the adhesive layer, and example thereof may be an ionizing radiation cured resin layer disposed in the state of embedding the reflective element. Further, when a space is provided between the reflecting member and the dielectric layer, the planarizing layer may be provided with a function of protecting the reflective element.

(6) Fixing Layer

When the frequency selective reflector of the present disclosure is used by being attached to, for example, a wall or the like, a fixing layer having a mechanism for attaching the frequency selective reflector may be disposed on the reflecting member in an opposite side to the dielectric layer. In order to inhibit interference among the fixing layer, the reflecting member and the dielectric layer, a metal layer may also be disposed between the fixing layer and the reflecting member, and the fixing layer may also serve as a metal layer. In addition, when the frequency selective reflector of the present disclosure is attached to a wall or the like, the fixing layer may have a mechanism for making the angle in the normal direction of the frequency selective reflector variable so that the deviation between the designed incident direction and the reflection direction of the designed electromagnetic wave, and the incident direction and the reflection direction of the actual electromagnetic wave can be corrected.

(7) Anti-Reflective Layer

Because of the impact of reflections at the dielectric layer interface in the case of high frequencies, in the frequency selective reflector of the present disclosure, an anti-reflective layer may be disposed in the interface between the dielectric layer and the air. The anti-reflective layer may have, for example, a multilayer structure having a different dielectric constant, and may include a concave and convex structure smaller than the wavelength of the electromagnetic wave.

5. Other Points of Frequency Selective Reflector

The frequency selective reflector of the present disclosure reflects electromagnetic waves in a particular frequency band of 24 GHz or more to a direction different from a regular reflection direction. The frequency band of the electromagnetic waves is not particularly limited if it is 24 GHz or more, but in particular, it is preferably in the range of 24 GHz or more and 300 GHz or less. If the frequency band of the electromagnetic waves is in the above range, the frequency selective reflector of the present disclosure can be utilized for the fifth generation mobile communication system, so-called 5G.

The frequency selective reflector of the present disclosure can be used, for example, as a frequency selective reflector for communication, and is suitable as a frequency selective reflector for mobile communication, among others.

### II. Second Embodiment of Frequency Selective Reflector

The frequency selective reflector of the present embodiment is a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, in a graph setting: a horizontal axis as a relative position when a central position in the predetermined direction of a minimum thickness cell region having a minimum thickness is defined as 0, and a central position of the predetermined direction of a maximum thickness cell region having a maximum thickness is defined as 1; and a vertical axis as a thickness ratio of each cell region with respect to a thickness of the maximum thickness cell region when a thickness of the minimum thickness cell region is defined as 0, and a thickness of the maximum thickness cell region is defined as 1; when a point corresponding to a central position of the predetermined direction of each cell region and corresponding to a thickness ratio of each cell region with respect to a thickness of the maximum thickness cell region is plotted to obtain a regression line of a below formula (1):

y=ax (1),

a slope “a” of the regression line is 0.7 or more and 1.2 or less, a coefficient of determination of the regression line is 0.9 or more; and the dielectric layer includes, as the unit structure, at least a first unit structure including three or more of the cell region of which thickness differs from one another. Similarly to the frequency selective reflector of the first embodiment, the frequency selective reflector of the present embodiment controls a reflection direction of the electromagnetic waves by controlling a relative reflection phase distribution of the electromagnetic waves by the thickness distribution of the dielectric layer.

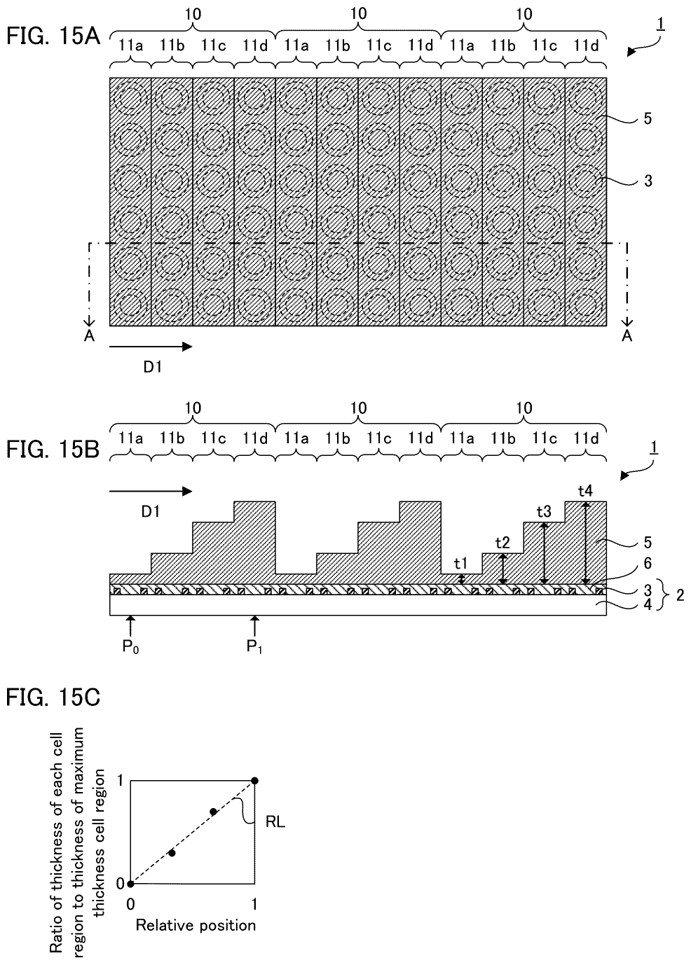

FIGS. 15A and 15B are schematic plan view and cross-sectional view showing an example of the frequency selective reflector of the present embodiment, and FIG. 15B is a cross-sectional view of A-A line in FIG. 15A. As shown in FIGS. 15A and 15B, frequency selective reflector 1 includes: reflecting member 2 reflecting particular electromagnetic waves; and dielectric layer 5 that: is disposed at an incident side of the electromagnetic waves with respect to the reflecting member 2; includes a concave and convex structure in which a plurality of unit structure 10 including a thickness distribution of which thickness t1 to t4 increase in predetermined direction D1 is arranged; and transmits particular electromagnetic waves. Also, the frequency selective reflector 1 may include adhesive layer 6 between the reflecting member 2 and the dielectric layer 5. The unit structure 10 of the dielectric layer 5 includes a plurality of cell regions 11a to 11d of which thickness t1 to t4 differs from one another. For example, in FIG. 15B, the unit structure 10 of the dielectric layer 5 has a stepped shape in which the thickness t1 to t4 increases stepwisely in the predetermined direction D1, the number of steps of the stepped shape is 4 stages, and the unit structure 10 of the dielectric layer 5 includes four cell regions 11a to 11d. In each cell region 11a to 11d of the unit structure 10 of the dielectric layer 5, since the thicknesses t1 to t4 are different, the round-trip optical path length when the electromagnetic wave is transmitted through the dielectric layer 5, reflected by the reflection member 2 and is emitted to the incident side of the electromagnetic wave by being transmitted through the dielectric layer 5 again, is different, and the difference in the round-trip optical path length in these dielectric layers, that is the optical path difference, will produce a relative reflection phase difference.

In this manner, in each cell region 11a to 11d of the unit structure 10 of the dielectric layer 5, the thickness t1 to t4 vary, thereby the round-trip optical path length in the dielectric layer 5 varies and the relative reflection phase of the electromagnetic wave varies; thus, the incident wave W1 of the electromagnetic wave can be reflected to a direction different from the regular reflection (specular reflection) direction, as exemplified in FIG. 2. In this case, the incident angle θ1 of the incident wave W1 of the electromagnetic wave is different from the reflection angle θ2 of the reflected wave W2 of the electromagnetic wave.

Then, in the unit structure 10 of the dielectric layer 5, in a graph setting: a horizontal axis as a relative position when a central position P₀ in the predetermined direction D1 of a minimum thickness cell region 11a having a minimum thickness t1 is defined as 0, and a central position P₁ of the predetermined direction D1 of a maximum thickness cell region 11d having a maximum thickness t4 is defined as 1; and a vertical axis as a thickness ratio of t1 to t4 of each cell region 11a to 11d with respect to a thickness t4 of the maximum thickness cell region 11d when a thickness t1 of the minimum thickness cell region 11a is defined as 0, and the thickness t4 of the maximum thickness cell region 11d is defined as 1; when a point corresponding to a central position of the predetermined direction D1 of each cell region 11a to 11d and corresponding to a thickness ratio of t1 to t4 of each cell region 11a to 11d with respect to the thickness t4 of the maximum thickness cell region 11d is plotted to obtain a regression line of a below formula (1):

y=ax (1),

a slope “a” of the regression line is in a predetermined range, and a coefficient of determination R 2 of the regression line is in a predetermined range.

FIG. 15C is a graph setting: a horizontal axis as a relative position when a central position P₀ in the predetermined direction D1 of the minimum thickness cell region 11a is defined as 0, and a central position P₁ of the predetermined direction D1 of the maximum thickness cell region 11d is defined as 1; and a vertical axis as a thickness ratio of t1 to t4 of each cell region 11a to 11d with respect to the thickness t4 of the maximum thickness cell region 11d when the thickness t1 of the minimum thickness cell region 11a is defined as 0, and the thickness t4 of the maximum thickness cell region 11d is defined as 1; and it is an example of a relative position and thickness ratio of each cell region of the unit structure of the dielectric layer in the frequency selective reflector shown in FIGS. 15A and 15B.

Also, when the central position of the minimum thickness cell region in the predetermined direction is defined as 0 and the central position of the maximum thickness cell region in the predetermined direction is defined as 1, the relative position is determined by the followings. Specifically, when the unit structure of the dielectric layer has N pieces (N≥3) of cell regions, for a n-th cell region (n=integer of 1 to N) from the cell region having the thinnest thickness, when the central position P₀ of the minimum thickness cell region in the predetermined direction is defined as 0 and the central position P₁ of the maximum thickness cell region in the predetermined direction is defined as 1, the central position Pₓ of the n-th cell region in the predetermined direction is determined by the following equation (2):

Pₓ=(distance between Pₓ and P₀ in the predetermined direction)/(distance between P₁ and P₀ in the predetermined direction) (2).

For example, in FIGS. 15A and 15B, when the widths of the cell regions 11a to 11d are equal, the relative positions of the central positions of the cell regions 11a to 11d of the unit structure 10 of the dielectric layer 5 in the predetermined direction D1 are respectively 0, 0.33, 0.67, and 1.

Also, the thickness ratio of each cell region to the thickness of the maximum thickness cell region when the thickness of the minimum thickness cell region is defined as 0 and the thickness of the maximum thickness cell region is defined as 1 is determined by the followings. Specifically, when the unit structure of the dielectric layer includes N pieces (N≥3) of cell regions, for the n-th cell region (n=integer of 1 to N) from the cell region having the thinnest thickness, when the thickness Tₘᵢₙ of the minimum thickness cell region is defined as 0 and the thickness Tₘₐₓ of the maximum thickness cell region is defined 1, the ratio of the thickness Tₙ of the n-th cell region to the thickness Tₘₐₓ of the maximum thickness cell region is determined by the following equation (3):

Thickness ratio=(Tₙ−Tₘᵢₙ)/(Tₘₐₓ−Tₘᵢₙ) (3)

For example, in FIGS. 15A and 15B, the thickness ratio=(T₁−T₁)/(T₄−T₁)=0 for the cell region (minimum thickness cell region) 11a. For the cell region 11b, the thickness ratio=(T₂−T₁)/(T₄−T₁). For the cell region 11c, the thickness ratio=(T₃−T₁)/(T₄−T₁). For the cell region (maximum thickness cell region) 11d, the thickness ratio=(T₄−T₁)/(T₄−T₁)=1.

Then, as shown in FIG. 15C, when a point corresponding to a central position of each cell region 11a to 11d of the unit structure 10 of the dielectric layer 5 in the predetermined direction D1 and corresponding to the thickness ratio of t1 to t4 of each cell region 11a to 11d with respect to the thickness t4 of the maximum thickness cell region 11d is plotted to obtain a regression line RL of a below formula (1):

y=ax (1),

a slope “a” of the regression line RL is in a predetermined range, and a coefficient of determination R² of the regression line RL is in the predetermined range.

When the thickness Tₘᵢₙ of the minimum thickness cell region is defined as 0 and the thickness Tₘₐₓ of the maximum thickness cell region is defined as 1, the ratio of the thickness Tₘᵢₙ of the minimum cell region to the thickness Tₘₐₓ of the maximum thickness cell region is (Tₘᵢₙ−Tₘᵢₙ)/(Tₘₐₓ−Tₘᵢₙ)=0, as determined by equation (3) above. Therefore, the y-section in the regression line of formula (1) is 0.

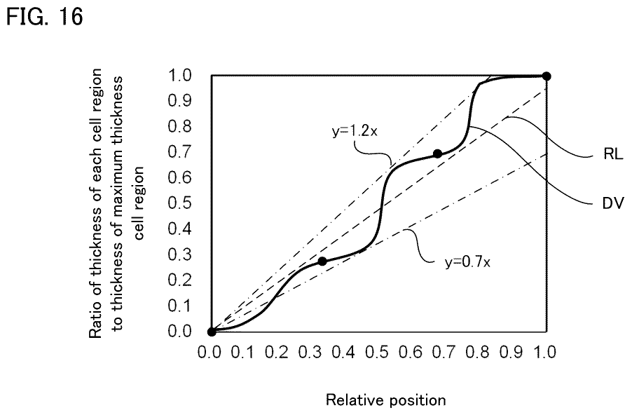

FIG. 16 is an example of a design value DV when the vertical and horizontal axes are the same as those of FIG. 15C, and the relative reflection phase of electromagnetic waves in each cell region is designed to be a predetermined setting in the unit structure of the dielectric layer. The design value DV is generally indicated by a curved line. Preferably, in the unit structure of the dielectric layer, the actual values are well aligned with the design values DV. For this reason, it is considered to derive a regression curve from the actual measurements. However, the curve of the design value DV is appropriately set according to the wavelength of the electromagnetic wave, the dielectric constant of the dielectric layer, and the target reflection properties, etc. Thus, it is difficult to derive the regression curve from the actual measurement, and it is difficult to derive a regression curve from the actual measurement and evaluate the difference from the design value. Then, in the present embodiment, a regression line is determined from the actual measurement values.

In addition, in the unit structure of the dielectric layer, it is possible to reflect the electromagnetic wave to a direction different from the regular reflection direction, even if the actual measurement value is slightly different from the design value. Thus, the slope “a” of the regression line is set to 0.7 or more and 1.2 or less after the coefficient of determination R 2 of the regression line is set to 0.9 or more. If the coefficient of determination R 2 of the regression line is equal to or greater than the predetermined value and the slope “a” of the regression line is within the predetermined range, the difference between the actual measurement value and the design value can be kept within the predetermined range.

Therefore, in the frequency selective reflector of this embodiment, by varying the thickness of each cell region of the unit structure of the dielectric layer, the round-trip optical path length in the dielectric layer can be varied per cell region, and the reflection phase of the electromagnetic wave can be controlled. Also, the desired reflection phase can be obtained by setting the slope and the coefficient of determination of the regression line determined as described above to a predetermined range. As a result, the reflection direction of the electromagnetic wave with respect to the predetermined incident direction can be controlled in any direction.

Further, the frequency selective reflector of the present embodiment can exhibit an effect same as that of the frequency selective reflector of the first embodiment.

Each configuration of the frequency selective reflector of the present embodiment will be hereinafter explained.

1. Dielectric Layer

The dielectric layer in the present embodiment is a member that is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves in a particular frequency band. Also, the unit structure of the dielectric layer includes a plurality of cell regions of which thickness differs from one another; in each of the unit structure of the dielectric layer, in a graph setting: a horizontal axis as a relative position when a central position in the predetermined direction of a minimum thickness cell region having a minimum thickness is defined as 0, and a central position of the predetermined direction of a maximum thickness cell region having a maximum thickness is defined as 1; and a vertical axis as a thickness ratio of each cell region with respect to a thickness of the maximum thickness cell region when a thickness of the minimum thickness cell region is defined as 0, and a thickness of the maximum thickness cell region is defined as 1; when a point corresponding to a central position of the predetermined direction of each cell region and corresponding to a thickness ratio of each cell region with respect to a thickness of the maximum thickness cell region is plotted to obtain a regression line of a below formula (1):

y=ax (1),

a slope “a” of the regression line is 0.7 or more and 1.2 or less, and a coefficient of determination of the regression line is 0.9 or more. Also, the dielectric layer includes, as the unit structure, at least a first unit structure including three or more of the cell region of which thickness differs from one another.

(1) Structure of Dielectric Layer

The dielectric layer includes a concave and convex structure in which a plurality of a unit structure including a thickness distribution of increasing thickness in a predetermined direction is arranged.

The unit structure of the dielectric layer includes a plurality of cell regions of which thickness differs from one another; wherein, in each of the unit structure of the dielectric layer, in a graph setting: a horizontal axis as a relative position when a central position in the predetermined direction of a minimum thickness cell region having a minimum thickness is defined as 0, and a central position of the predetermined direction of a maximum thickness cell region having a maximum thickness is defined as 1; and a vertical axis as a thickness ratio of each cell region with respect to a thickness of the maximum thickness cell region when a thickness of the minimum thickness cell region is defined as 0, and a thickness of the maximum thickness cell region is defined as 1; when a point corresponding to a central position of the predetermined direction of each cell region and corresponding to a thickness ratio of each cell region with respect to a thickness of the maximum thickness cell region is plotted to obtain a regression line of a below formula (1):

y=ax (1),

a slope “a” of the regression line is 0.7 or more and 1.2 or less, a coefficient of determination of the regression line is 0.9 or more.

The slope “a” of the regression line is 0.7 or more and 1.2 or less, preferably 0.75 or more and 1.15 or less, and more preferably 0.8 or more and 1.1 or less.

Also, the coefficient of determination R 2 of the regression line is 0.9 or more, preferably 0.92 or more and 0.99 or less, and more preferably 0.94 or more and 0.98 or less.

Here, the regression line is determined by the least squares method.

Also, in the graph, the horizontal axis is a relative position when the central position of the minimum thickness cell region having the minimum thickness in the predetermined direction is defined as 0, and the central position of the maximum thickness cell region having the maximum thickness in the predetermined direction is defined as 1. The predetermined direction is a direction in which the thickness increases from the minimum thickness cell region in the thickness distribution of the unit structure of the dielectric layer. For the relative position, a point corresponding to a central position of each cell region in the predetermined direction is plotted.

Incidentally, when the unit structure of the dielectric layer has a tapered shape, it may be difficult to identify the cell region since the number of cell regions is considered to be infinite. Thus, when the unit structure of the dielectric layer has a tapered shape, if the reflecting member includes a dielectric substrate and a reflective element, the region in which one reflective element is arranged can be considered as a cell region, and the central position of each cell region in a predetermined direction can be determined. In the case where the unit structure of the dielectric layer has a tapered shape, if the reflecting member includes a reflective layer, for example, the unit structure of the dielectric layer is equally divided in the predetermined direction by a length less than half of the wavelength in the air of the reflected electromagnetic wave, and each divided region is considered as a cell region to determine the central position of each cell region in the predetermined direction. The number of equally dividing the unit structure of the dielectric layer in the predetermined direction is, for example, 3 or more, and preferably 6 or more.

When the central position in the predetermined direction of the minimum thickness cell region having the minimum thickness is defined as 0, and the central position in the predetermined direction of the maximum thickness cell region having the maximum thickness is defined as 1, the relative position of the central position in the predetermined direction of each cell region is determined by the equation (2), as described above.

For example, in FIGS. 15A to 15C, when the widths of the cell regions 11a to 11d of the unit structure 10 of the dielectric layer 5 are equal, the relative positions of the central positions of each of the cell regions 11a to 11d of the unit structure 10 of the dielectric layer 5 are respectively 0, 0.33, 0.67, and 1.

In the graph above, the vertical axis is the thickness ratio of each cell region to the thickness of the maximum thickness cell region when the thickness of the minimum thickness cell region is defined as 0 and the thickness of the maximum thickness cell region is defined as 1. The thickness of the minimum thickness cell region is the thickness of the central position in the predetermined direction of the minimum thickness cell region. The thickness of the maximum thickness cell region is also the thickness of the central position in the predetermined direction of the maximum thickness cell region. The thickness of the cell region is the thickness in the central position of the cell region in the predetermined direction. The central position of the cell region in the predetermined direction is as described above.

Also, the thickness ratio of each cell region to the thickness of the maximum thickness cell region when the thickness of the minimum thickness cell region is defined as 0 and the thickness of the maximum thickness cell region is defined as 1 is determined by the equation (3) as described above.

For example, in FIGS. 15A and 15B, the thickness ratio=(T₁−T₁)/(T₄−T₁)=0 for the cell region (minimum thickness cell region) 11a. For the cell region 11b, the thickness ratio=(T₂−T₁)/(T₄−T₁). For the cell region 11c, the thickness ratio=(T₃−T₁)/(T₄−T₁). For the cell region (maximum thickness cell region) 11d, the thickness ratio=(T₄−T₁)/(T₄−T₁)=1.

The thickness of each cell region is, for example, a value measured using a thickness measurement technique having a thickness resolution of about 1 μm. For example, the thickness of each cell region may be a value measured by observing the cross-section in the thickness direction of the unit structure with an optical microscope.

Also, the distance between the central position of the minimum thickness cell region in the predetermined direction and the central position in the predetermined direction of the arbitrary cell region, and the distance between the central position in the predetermined direction of the maximum thickness cell region and the central position in the predetermined direction of the arbitrary cell region is, for example, a value measured using a measurement technique having a resolution of at least about 0.01 mm. The measurement technique can be appropriately selected and used from various length measuring instruments such as a three-dimensional measuring machine. Further, when measuring the thickness of each cell region, if the concave and convex shape distribution on the surface of the dielectric layer is measured, the above distance may be calculated simultaneously.

The unit structure of the dielectric layer includes a thickness distribution of increasing thickness in a predetermined direction. The unit structure of the dielectric layer may, for example, include a thickness distribution in which the thickness increases in only one direction, or may include a thickness distribution in which the thickness increases in two directions of a first direction and a second direction perpendicular to the first direction.

When the unit structure of the dielectric layer includes a thickness distribution in which the thickness increases in only one direction, the point is plotted in the graph setting a horizontal axis as a relative position of that one direction, and the regression line is determined. Also, when the unit structure of the dielectric layer includes a thickness distribution in which the thickness increases in two directions orthogonal to each other, the point is respectively plotted in the graph setting a horizontal axis as the relative positions of the two directions respectively, and the regression line is respectively determined in each graph.

The other points of the structure of the dielectric layer can be the same as those of the first embodiment described above.

(2) Properties of the Dielectric Layer

The properties of the dielectric layer are the same as those of the first embodiment described above.

(3) Material of Dielectric Layer

The materials of the dielectric layer are the same as those of the first embodiment described above.

(4) Method for Forming Dielectric Layer

The method for forming the dielectric layer is the same as that of the first embodiment described above.

2. Reflecting Member

The reflecting member in the present embodiment is a member that reflects electromagnetic waves in a particular frequency band. The reflecting member is the same as that of the first embodiment described above.

3. Control of Reflection Direction of Electromagnetic Waves

In the present embodiment, the control of the reflection direction of electromagnetic waves is the same as that of the first embodiment described above.

4. Other Configurations

The frequency selective reflector of the present embodiment may include other configurations as required in addition to the reflecting member and the dielectric layer described above. The other configurations are the same as those of the first embodiment described above.

5. Other Points of Frequency Selective Reflector

In the present embodiment, the frequency band of the electromagnetic wave and applications are the same as those of the first embodiment described above.

### III. Third Embodiment of Frequency Selective Reflector

The frequency selective reflector of the present embodiment is a frequency selective reflector reflecting electromagnetic waves in a particular frequency band of 24 GHz or more to a direction different from a regular reflection direction, the frequency selective reflector comprising: a reflecting member reflecting the electromagnetic waves; and a dielectric layer that: is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves, wherein the unit structure of the dielectric layer includes a plurality of cell regions of which thickness differs from one another; in each of the unit structure of the dielectric layer, a difference between a minimum thickness and a maximum thickness is 0.2 mm or more and 15 mm or less; and the dielectric layer includes, as the unit structure, at least a first unit structure including three or more of the cell regions of which thickness differs from one another. Similarly to the frequency selective reflector of the first embodiment, the frequency selective reflector of the present embodiment controls a reflection direction of the electromagnetic waves by controlling a relative reflection phase distribution of the electromagnetic waves by the thickness distribution of the dielectric layer.

The frequency selective reflector of the present embodiment will be explained with reference to drawings. FIGS. 1A and 1B are a schematic plan view and cross-sectional view showing an example of the frequency selective reflector of the present embodiment, and FIG. 1B is a cross-sectional view of A-A line in FIG. 1A. As shown in FIGS. 1A and 1B, frequency selective reflector 1 includes: reflecting member 2 reflecting particular electromagnetic waves; and dielectric layer 5 that: is disposed at an incident side of the electromagnetic waves with respect to the reflecting member 2; includes a concave and convex structure in which a plurality of unit structure 10 including a thickness distribution of which thickness t1 to t6 increase in predetermined direction D1 is arranged; and transmits particular electromagnetic waves. Also, the frequency selective reflector 1 may include adhesive layer 6 between the reflecting member 2 and the dielectric layer 5. The unit structure 10 of the dielectric layer 5 includes a plurality of cell regions 11a to 11f of which thickness t1 to t6 differs from one another. For example, in FIG. 1B, the unit structure 10 of the dielectric layer 5 has a stepped shape in which the thickness t1 to t6 stepwisely increase in the predetermined direction D1, the number of steps in the stepped shape is six stages, and the unit structure 10 of the dielectric layer 5 includes six cell regions 11a to 11f. Since the thicknesses t1 to t6 are different in each cell region 11a to 11f of the unit structure 10 of the dielectric layer 5, the round-trip optical path length when the electromagnetic waves are transmitted through the dielectric layer 5, reflected by the reflecting member 2, and emitted to the incident side of the electromagnetic wave by being transmitted through the dielectric layer 5 again, are different. Thus, the differences in round-trip optical path length in the dielectric layers, that is, the optical path difference, will produce a relative reflection phase difference.

In this manner, in each cell region 11a to 11f of the unit structure 10 of the dielectric layer 5, when the thicknesses t1 to t6 vary, the round-trip optical path length in the dielectric layer 5 varies, and the relative reflection phase of the electromagnetic wave varies. Thus, as exemplified in FIG. 2, the incident wave W1 of the electromagnetic wave can be reflected to a direction different from the regular reflection (specular reflection) direction. In this case, the incident angle θ1 of the incident wave W1 of the electromagnetic wave is different from the reflection angle θ2 of the reflected wave W2 of the electromagnetic wave.

Accordingly, in the frequency selective reflector of the present embodiment, by varying the thickness of each cell region of the unit structure of the dielectric layer, the round-trip optical path length in the dielectric layer is varied per cell region, and the reflection phase of the electromagnetic wave can be controlled. As a result, the reflection direction of the electromagnetic wave with respect to the predetermined incident direction can be controlled in any direction.

Also, in the unit structure 10 of the dielectric layer 5, a difference between a minimum thickness t1 and a maximum thickness t6 is in the predetermined range.

Here, the effective wavelength λ_{g} of the electromagnetic wave propagating in the dielectric layer is represented by λ_{g}=λ₀/√ε, where λ₀ is the wavelength in the free space corresponding to the frequency f of the particular electromagnetic wave and c is the relative dielectric constant of the dielectric layer. Thus, as described in the first embodiment above, when the thickness of each cell region is, for example, about α+0λ_{g} or more and α+2λ_{g} or less, when the dielectric constant of the dielectric layer is low, the thickness of each cell region increases, and when the dielectric constant of the dielectric layer is high, the thickness of each cell region decreases. Thus, when the dielectric constant of the dielectric layer is low, the difference between the minimum thickness and the maximum thickness tends to increase, and when the dielectric constant of the dielectric layer is high, the difference between the minimum thickness and the maximum thickness tends to decrease.

In the unit structure of the dielectric layer, if the difference between the minimum thickness and the maximum thickness is too large, the overall thickness of the frequency selective reflector becomes thicker, which may cause constraints on the installation and may result in poor handling. There is also a risk of increasing manufacturing costs. On the other hand, to reduce the difference between the minimum thickness and the maximum thickness, it is necessary to increase the dielectric constant of the dielectric layer, as described above. However, the higher the dielectric constant of the dielectric layer, the greater the dielectric loss and the greater the reflection at the dielectric interface. As a result, reflection to the designed direction is reduced. Thus, if the difference between the minimum thickness and the maximum thickness is too small, there is a risk that losses including dielectric loss and interfacial reflections may be increased.

In contrast, in the present embodiment, since the difference between the minimum thickness and the maximum thickness in the unit structure of the dielectric layer is equal to or less than the predetermined value, the overall thickness of the frequency selective reflector can be reduced. Thus, restrictions on installation can be reduced and handling can be improved. Also, since the difference between the minimum thickness and the maximum thickness in the unit structure of the dielectric layer is equal to or greater than the predetermined value, it is not necessary to increase the dielectric constant of the dielectric layer in order to reduce the difference between the minimum thickness and the maximum thickness. For this reason, losses including dielectric loss and interfacial reflections can be reduced.

Further, the frequency selective reflector of the present embodiment can exhibit an effect same as that of the frequency selective reflector of the first embodiment described above.

Each configuration of the frequency selective reflector of the present embodiment will be hereinafter explained.

1. Dielectric Layer

The dielectric layer in the present embodiment is a member that is disposed at an incident side of the electromagnetic waves with respect to the reflecting member; includes a concave and convex structure in which a plurality of a unit structure including a thickness distribution of increasing thickness in a predetermined direction is arranged; and transmits the electromagnetic waves in a particular frequency band. Also, the unit structure of the dielectric layer includes a plurality of cell regions of which thickness differs from one another, and in each unit structure of the dielectric layer, the difference between the minimum thickness and the maximum thickness is in the predetermined range.

(1) Structure of Dielectric Layer

The dielectric layer includes a concave and convex structure in which a plurality of a unit structure including a thickness distribution of increasing thickness in a predetermined direction is arranged.

The unit structure of the dielectric layer includes a plurality of cell regions of which thickness differs from one another, and in each unit structure of the dielectric layer, the difference between the minimum thickness and the maximum thickness is in the predetermined range.

Incidentally, the difference between the minimum thickness and the maximum thickness in the unit structure of the dielectric layer is the same as that of the first embodiment described above.

Also, other points of the structure of the dielectric layer can be the same as those of the first embodiment described above.

(2) Properties of the Dielectric Layer

The properties of the dielectric layer are the same as those of the first embodiment described above.

(3) Material of Dielectric Layer

The materials of the dielectric layer are the same as those of the first embodiment described above.

(4) Method for Forming Dielectric Layer

The method for forming the dielectric layer is the same as that of the first embodiment described above.

2. Reflecting Member

The reflecting member in the present embodiment is a member that reflects electromagnetic waves in a particular frequency band. The reflecting member is the same as that of the first embodiment described above.

3. Control of Reflection Direction of Electromagnetic Waves

In the present embodiment, the control of the reflection direction of electromagnetic waves is the same as that of the first embodiment described above.

4. Other Configurations

The frequency selective reflector of the present embodiment may include other configurations as required in addition to the reflecting member and the dielectric layer described above. The other configurations are the same as those of the first embodiment described above.

5. Other Points of Frequency Selective Reflector

In the present embodiment, the frequency band of the electromagnetic wave and applications are the same as those of the first embodiment described above.

B. Dielectric Layer

The dielectric layer in the present disclosure is a member used for the frequency selective reflector described above.

Incidentally, the dielectric layer is the same as that described in the section “A. Frequency selective reflector” above; thus, the descriptions herein are omitted.

C. Reflecting Structure

The reflecting structure of the present disclosure is a reflecting structure comprising: a frequency selective reflector reflecting electromagnetic waves in a particular frequency band to a direction different from a regular reflection direction; and a protective member arranged in an upper side of the frequency selective reflector, wherein a thickness of the protective member is less than ¼ of an effective wavelength of the electromagnetic waves propagating in the protective member.

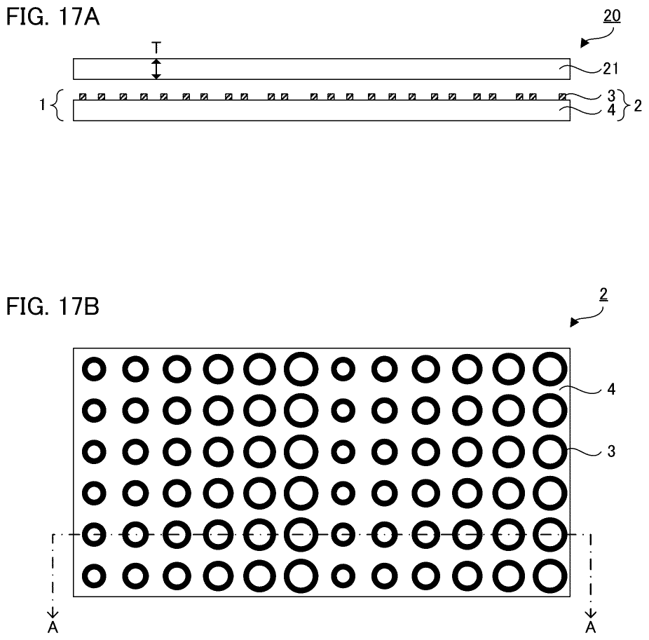

FIG. 17A is a schematic cross-sectional view showing an example of the reflecting structure of the present disclosure, and FIG. 17B is a schematic plan view showing an example of the frequency selective reflector in the reflecting structure of the present disclosure. As shown in FIG. 17A, the reflecting structure 20 comprises: a frequency selective reflector 1 reflecting electromagnetic waves in a particular frequency band to a direction different from a regular reflection direction; and a protective member 21 arranged in an upper side of the frequency selective reflector 1.

As shown in FIGS. 17A and 17B, the frequency selective reflector 1 includes a reflecting member 2 reflecting the electromagnetic wave in a particular frequency band, and the reflecting member 2 is the one in which a plurality of ring-shaped reflective element 3 is arranged, and includes a dielectric substrate 4, and a plurality of reflective element 3 arranged on the protective member 21 side surface of the dielectric substrate 4. The reflecting member 2 has a reflection phase control function controlling the reflection phase of the electromagnetic wave, and for example, in the reflecting member 2 shown in FIG. 17B, by varying the size of the reflective element 3, the resonance frequency can be varied per reflective element 3 to control the reflection phase of the target electromagnetic wave. As a result, the reflection direction of the electromagnetic wave with respect to the predetermined incident direction can be controlled in any direction. Incidentally, regarding the reflecting member shown in FIGS. 17A and 17B, FIG. 17A corresponds to a cross-sectional view of A-A line in FIG. 17B.

Also, as shown in FIG. 17A, thickness T of the protective member 21 is less than ¼ of an effective wavelength of the electromagnetic waves in a particular frequency band propagating in the protective member 21.

In the reflecting structure of the present disclosure, the thickness of the protective member is less than ¼ of the effective wavelength of the electromagnetic wave, and is sufficiently thin with respect to the effective wavelength of the electromagnetic wave, and thus attenuation of the electromagnetic wave due to the protective member can be suppressed. As such, the distance between the frequency selective reflector and the protective member need not be a specific value. Thus, in the present disclosure, it is possible to suppress the attenuation of electromagnetic waves due to the protective member without limiting the design.

Here, the effective wavelength of the electromagnetic wave means the wavelength when the electromagnetic wave passes through materials other than air, such as a protective member. It should be noted that the wavelength is simply referred to as the wavelength in the air.

Hereinafter, each configuration of the reflecting structure in the present disclosure will be described.

1. Protective Member

The protective member in the present disclosure is arranged in an upper side of the frequency selective reflector, and includes a predetermined thickness.

(1) Thickness of Protective Member

The thickness of the protective member is less than ¼ of the effective wavelength of the electromagnetic wave in a particular frequency band propagating in the protective member, and in particular, it is preferably ⅙ or less of the effective wavelength, and more preferably 1/15 or less of the effective wavelength. When the thickness of the protective member is thin as in the above range, the attenuation of the electromagnetic wave due to the protective member can be suppressed. Also, when the thickness of the protective member is 1/15 or less of the effective wavelength, the attenuation of the electromagnetic wave due to the protective member can be significantly suppressed. As described later, the frequency band of the electromagnetic wave is preferably 24 GHz or more, that is, the wavelength of the electromagnetic wave in the air is preferably 12.49 mm or less. In this case, when the protective member uses a material whose effective wavelength is close to the wavelength in the air, the thickness of the protective member is about 3.1 mm. As a result, the thickness of the protective member can be, in particular, about 3.1 mm or less. Also, the thickness of the protective member is preferably the thinner the better from the viewpoint of suppressing the attenuation of the electromagnetic wave, but is preferably 5 μm or more from the viewpoint of protection of the frequency selective reflector and the strength, rigidity, etc. of the protective member, more preferably 50 μm or more, and further preferably 100 μm or more.

The thickness of the protective member refers to the total thickness of the protective member, for example, when the protective member has a multilayer structure including a plurality of layers as described below.

Here, the effective wavelength λ_{g} of the electromagnetic wave propagating in the protective member is represented by λ_{g}=λ₀/\sqrt{ε} when the wavelength in the free space corresponding to the frequency f of the particular electromagnetic wave is defined as λ₀ and the relative dielectric constant of the protective member is defined as E. Thus, the thickness of the protective member is less than Δ_{g}/4. Incidentally, as described above, when the protective member has a multilayer structure including n-pieces of layer, when the thickness of a i-th layer (i=integer of 1 to n) from the incident side of the electromagnetic wave is defined as T₁, the effective wavelength of the electromagnetic wave propagating in the layer is defined as λ_{gi}, and the thickness of the layer is how many wavelength of the effective wavelength of the electromagnetic wave is represented by Nᵢ=Tᵢ/λ_{gi}, the sum of N₁ to Nₙ is less than ¼.

(2) Structure of Protective Member

The protective member may have a single layer structure configured by one layer, and may have a multilayer structure including a plurality of layer.

The protective member may, for example, include at least a protective sheet. Also, the protective member may, for example, include an adhesive layer and a protective sheet in this order from the frequency selective reflector side.

(a) Protective Sheet

The protective sheet configuring the protective member in the present disclosure is a member that protects the frequency selective reflector.

(i) Properties of Protective Sheet

The protective sheet transmits the electromagnetic wave in a particular frequency band, and may or may not transmit the electromagnetic waves in other frequency bands.

Preferably, the dielectric loss tangent of the protective sheet to a particular electromagnetic wave is relatively small. The small dielectric loss tangent of the protective sheet can reduce dielectric loss and reduce high frequency losses. Specifically, the dielectric loss tangent of the protective sheet with respect to the electromagnetic waves of the target frequency is preferably 0.05 or less, may be 0.01 or less, and may be 0.001 or less. Also, the dielectric loss tangent of the protective sheet is preferably the smaller the better, and the lower limit value is not particularly limited.

In addition, the dielectric constant of the protective sheet in the electromagnetic wave of the target frequency is preferably the lower the better to reduce the loss, but in the present disclosure, since the loss can be reduced by reducing the thickness of the protective member, for example, the dielectric constant may be 10 or less.

Here, the dielectric loss tangent and dielectric constant of the protective sheet can be measured by a resonator method.

(ii) Material of Protective Sheet

The material of the protective sheet is not particularly limited if it is, for example, a non-conductive material capable of transmitting electromagnetic waves in a particular frequency band, and specifically, a resin, glass, quartz, ceramics, or the like can be used.

The non-conductive material refers to a material of which volume resistivity is 10¹² Ω·cm or more. The volume resistivity of the protective sheet can be measured according to JIS C 2151.

Among the materials of the protective sheet, a resin is preferred in terms of moldability, cost, and etc.

Although the resin is not particularly limited if it is capable of transmitting electromagnetic waves in a particular frequency band, it is preferable that the resin has a relatively low absorption of the electromagnetic wave and has a relatively high transmittance of the electromagnetic wave. More preferably, the resin is the one that meets the aforementioned dielectric loss tangent and dielectric constant. In addition, it is particularly preferred that the resin is relatively high in strength, stiffness, weather resistance, and the like. Examples of such resins may include general purpose plastics, engineering plastics, and the like. Examples of the resin also include a curable resin such as a thermosetting resin or an ionizing radiation curable resin. Ionizing radiation includes visible light, ultraviolet light, X-ray, electron beam, ion beam, and the like. Melamine resins and diallyl phthalate resins may also be used as the resin.

If the protective sheet contains a resin, as required, for example, an additive such as an ultraviolet absorber, a light stabilizer, an antioxidant, or the like may be included.

(iii) Structure of Protective Sheet

The protective sheet may have a single layer structure configured by one layer, and may have a multilayer structure including a plurality of layer.

If the material of the protective sheet is a resin, that is, when the protective sheet is a resin sheet, the protective sheet includes at least a resin layer.

Also, when the protective sheet is a resin sheet, a design may be imparted by the protective sheet. In this case, the protective sheet may include, for example, at least a resin layer and a design layer, or at least a resin layer also serving as a design layer.

(iii-1) when Protective Sheet Includes at Least Resin Layer and Design Layer

When the protective sheet includes at least a resin layer and a design layer, for example, it may include a resin layer that is a resin substrate and a design layer, and may include a paper substrate, a design layer, and a resin layer that is a coat layer.

(iii-1-1) when Protective Sheet Includes Resin Layer that is Resin Substrate and Design Layer

When the protective sheet includes a resin layer that is a resin substrate and a design layer, there are no particular limitations on the layer structure of the protective sheet. The protective sheet may include, in the order from the frequency selective reflector side, for example, a resin layer, a design layer, and a surface protecting layer; a resin layer, a design layer, a primer layer, and a surface protecting layer; a first resin layer, a design layer, an adhesive agent layer, a second resin layer, and a surface protecting layer; a first resin layer, a design layer, an adhesive agent layer, a second resin layer, a primer layer, and a surface protecting layer; a design layer, a resin layer, and a surface protecting layer; and a design layer, an adhesive agent layer, a resin layer, a primer layer and a surface protecting layer. Also, when the design layer is disposed on the resin layer including the protection function, the resin layer and the design layer may be separable or the resin layer and the design layer and the surface protecting layer may be separable so that only the design layer can be changed. In this case, a pressure-sensitive adhesive layer or an adhesive layer having removability may be disposed between each layer, or each layer may be configured to be structurally adhered.

In the above case, as the material of the resin layer, a material with which a resin substrate can be obtained may be used, and may be appropriately selected from the resins described above. The thickness of the resin layer is not particularly limited if the thickness of the protective member can be in the predetermined range, and can be, for example, about several tens of μm to several hundreds of μm. The resin layer may be optionally colored. Also, the resin layer may be subjected to surface treatment such as, for example, corona treatment, plasma treatment, and ozone treatment, and the primer layer may be arranged in order to enhance adhesion to adjacent layers.

Further, in the above case, the design layer is a layer that imparts designability to the protective member, and examples thereof may include a colored layer, a picture pattern layer, a pattern layer, and the like. The design layer may be formed by, for example, a printing method or a transfer method. The thickness of the design layer is not particularly limited if the thickness of the protective member can be in the predetermined range, and can be, for example, about several hundreds of nm to several tens of μm.

In the above case, the surface protecting layer is a layer configured to impart surface properties such as scratch resistance, abrasion resistance, water resistance, stain resistance, etc. to the protective member. As the material of the surface protecting layer, a curable resin such as a thermosetting resin or an ionizing radiation curable resin can be used. In particular, the ionizing radiation curable resin is preferable, an ultraviolet curable resin or an electron beam curable resin is more preferable, and an electron beam curable resin is further preferable. Ionizing radiation includes visible light, ultraviolet light, X-ray, electron beam, ion beam, and etc., but in particular, ultraviolet light and electron beam are preferable, and electron beam is further preferable.

It is preferable that the surface protecting layer has water repellency. The degrade in the reflection properties of the reflecting structure due to the adhesion of water to the surface of the protective member can be prevented. Preferably, the water repellency of the surface protecting layer is, for example, 90° or more in contact angle with water on the surface of the surface protecting layer. The contact angle of water can be measured by the θ/2 method.

To impart water repellency to the surface protecting layer, for example, a water repellent agent such as a silicone-based water repellent agent or a fluorine-based water repellent agent can be added, or a siloxane bond or fluorine can be introduced into the main chain or the side chain.

The thickness of the surface protecting layer is not particularly limited if the thickness of the protective member can be in the predetermined range, and can be, for example, about several μm to several tens of μm.

Also, in the above case, for example, a general dry laminate adhesive may be used for the adhesive agent layer. The thickness of the adhesive agent layer is not particularly limited if the thickness of the protective member can be in the predetermined range, and can be, for example, about several hundreds of nm to several tens of μm.

Also, in the above case, a general primer agent may be used for the primer layer. The thickness of the primer layer is not particularly limited if the thickness of the protective member can be in the predetermined range, and can be, for example, about several hundreds of nm to several tens of μm.

(iii-1-2) when Protective Sheet Includes Paper Substrate, Design Layer, and Resin Layer that is Coat Layer

When the protective sheet includes a paper substrate, a design layer, and a resin layer that is a coat layer, the layer structure of the protective sheet is not particularly limited, and the protective sheet may, for example, include a paper substrate, a design layer, and a resin layer in this order from the frequency selective reflector side.

In the above case, the material of the resin layer may be the one capable of coating, and the above described curable resin can be used.

It is preferable that the rein layer has water repellency. The degrade in the reflection properties of the reflecting structure due to the adhesion of water to the surface of the protective member can be prevented. The water repellency of the resin layer may be the same as the water repellency of the surface protecting layer in (iii-1-1) described above.

To impart water repellency to the resin layer, for example, a water repellent agent such as a silicone-based water repellent agent or a fluorine-based water repellent agent can be added, or a siloxane bond or fluorine can be introduced into the main chain or the side chain.

The thickness of the resin layer is not particularly limited if the thickness of the protective member can be in the predetermined range, and can be, for example, about several μm to several tens of μm.

Also, in the above case, the design layer is a layer that imparts designability to the protective member, and examples thereof may include a colored layer and a picture pattern layer. The design layer can be formed by, for example, printing on the paper substrate.

In addition, in the above case, examples of the paper substrate may include tissue paper and titanium paper. The thickness of the paper substrate is not particularly limited if the thickness of the protective member can be in the predetermined range, and can be, for example, about 25 μm or more and 135 μm or less.

(iii-2) when Protective Sheet Include at Least Resin Layer Also Serve as Design Layer

When the protective sheet includes at least a resin layer that also serves as a design layer, examples of the resin layer may include a resin-impregnated paper obtained by impregnating a printed paper substrate with a resin.

Examples of the resin configuring the resin-impregnated paper may include a melamine resin and a diallyl phthalate resin.

The paper substrate configuring the resin-impregnated paper is not particularly limited, if it is capable of being impregnated with the resin. Examples of the paper substrate configuring the resin-impregnated paper may include titanium paper, tissue paper, kraft paper, coated paper, art paper, vegetable parchment, glassine paper, parchment paper, paraffin paper, and Japanese paper.

The thickness of the resin layer is not particularly limited if the thickness of the protective member can be in the predetermined range, and can be, for example, about 25 μm or more and 250 μm or less.

In the above case, the layer structure of the protective sheet is not particularly limited, and for example, the protective sheet may include, in the order from the frequency selective reflector, a resin layer and a surface protecting layer, or a substrate layer, a resin layer, and a surface protecting layer.

In the above case, examples of the surface protecting layer may include a resin-impregnated paper obtained by impregnating a paper substrate with a resin. Examples of the resin configuring the resin-impregnated paper used for the surface protecting layer may include a melamine resin. Also, the paper substrate configuring the resin-impregnated paper used for the surface protecting layer may be the same as the paper substrate configuring the resin-impregnated paper used for the resin layer. The thickness of the surface protecting layer is not particularly limited if the thickness of the protective member can be in the predetermined range, and for example, can be about 25 μm or more and 250 μm or less.

Further, in the above case, examples of the substrate layer may include a resin-impregnated paper obtained by impregnating a paper substrate with a resin. Examples of the resin configuring the resin-impregnated paper used for the substrate layer may include a thermosetting resin such as a phenolic resin. Also, examples of the paper substrate configuring the resin-impregnated paper used for the substrate layer may include kraft paper. As the substrate layer, a plurality of pieces of kraft paper impregnated with a resin may be used. The thickness of the substrate layer is not particularly limited if the thickness of the protective member can be in the predetermined range. The thickness of the kraft paper may be, for example, about 50 μm or more and 200 μm or less.

(b) Adhesive Layer

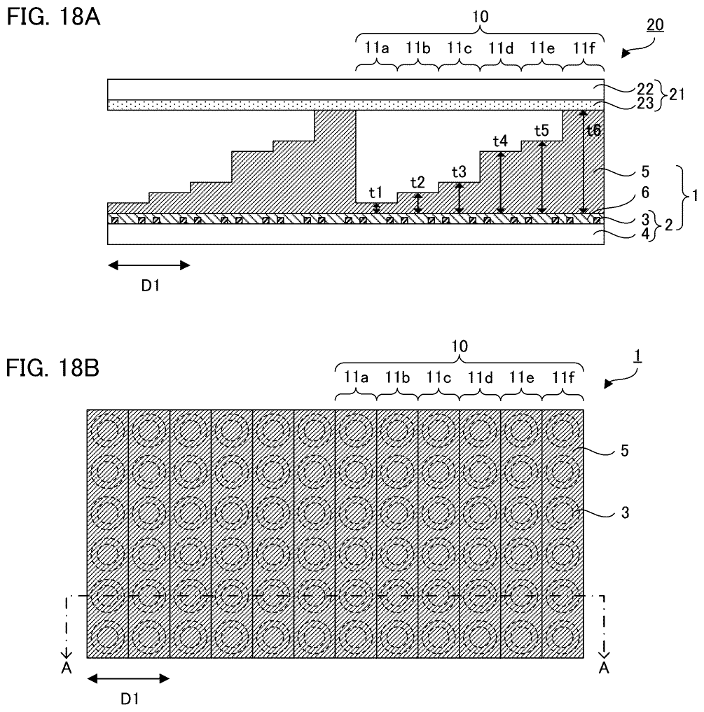

The protective member 21 in the present disclosure may include, for example, as shown in FIG. 18A, in the order form the frequency selective reflector 1 side, an adhesive layer 23, and a protective sheet 22. The adhesive layer is a layer configured to directly or indirectly adhere the protective member to the frequency selective reflector.

Adhesives used in the adhesive layer are not particularly limited and examples thereof may include epoxy-based adhesives, urethane-based adhesives, acrylic adhesives, and emulsion-based adhesives. The adhesive may also be a pressure sensitive adhesive or an optical clear adhesive. The adhesive may also use a liquid adhesive and may use a sheet-like adhesive. The pressure sensitive adhesive is also referred to as PSA. The optical clear adhesive is also referred to as OCA.

In addition, the adhesive layer may or may not have removability. If the adhesive layer has removability, it is possible to reapply the adhesive layer when the protective member is placed in the upper side of the frequency selective reflector, and it is possible to peel the protective member without leaving an adhesive residue when the protective member is replaced.

It should be noted that “removability” refers to a property that the one can be easily peeled off after the protective member is applied to the surface of the frequency selective reflector or a supporting member described later, without destroying the frequency selective reflector or the supporting member and without leaving the residue of the adhesive on the surface of the frequency selective reflector or the supporting member described later.

The thickness of the adhesive layer is not particularly limited if the thickness of the protective member can be in the predetermined range, and for example, can be about several hundreds of nm to several hundreds of μm.

(3) Position of Protective Member

In the present disclosure, the protective member is arranged in an upper side of the frequency selective reflector, and may be arranged so as to contact the frequency selective reflector, and may be arranged so as not to contact the frequency selective reflector. When the protective member is arranged so as to contact the frequency selective reflector, the protective member can be supported by the frequency selective reflector, and deflection of the protective member can be suppressed even when the thickness of the protective member is thin.

For example, as described later, when the frequency selective reflector includes a reflecting member that reflects particular electromagnetic waves, and if the reflecting member has a reflection phase control function that controls the reflection phase of the electromagnetic waves, the protective member is preferably arranged so as not to contact the reflecting member of the frequency selective reflector. When the protective member is in contact with the reflecting member of the frequency selective reflector, the reflection properties of the reflecting member may change. When the protective member needs to be arranged so as to be in contact with the reflecting member of the frequency selective reflector from the viewpoint of rigidity or the like, the reflection properties of the reflecting member may be redesigned in consideration of the change in the reflection properties by the protective member.

Also, for example, as described later, when the frequency selective reflector includes, in the order from the protective member side, a dielectric layer including a concave and convex structure in which a plurality of a unit structure including a thickness distribution of increasing thickness in a predetermined direction is arranged, and transmitting particular electromagnetic waves; and a reflecting member reflecting particular electromagnetic waves, the protective member is preferably arranged so as to contact the frequency selective reflector. As described above, the protective member can be supported by the frequency selective reflector, and deflection of the protective member can be suppressed even when the thickness of the protective member is thin.

Also, the protective member is preferably supported by at least one of the frequency selective reflector and the supporting member described later, and more preferably supported by both of the frequency selective reflector and the supporting member. By supporting the protective member, deflection of the protective member can be suppressed even when the thickness of the protective member is thin. Also, when the protective member is supported by both of the frequency selective reflector and the supporting member, the protective member can be certainly supported, and even when the thickness of the protective member is thin, the deflection of the protective member can be effectively suppressed. In this case, the thickness of the protective member can be made thinner.

When the protective member is arranged so as to contact the frequency selective reflector and when the frequency selective reflector includes, in the order from the protective member side, a dielectric layer including a concave and convex structure in which a plurality of a unit structure including a thickness distribution of increasing thickness in a predetermined direction is arranged, and transmitting particular electromagnetic waves; and a reflecting member reflecting particular electromagnetic waves, the protective member is preferably arranged so as to contact the maximum thickness portion having the maximum thickness in the dielectric layer. In specific, as described later, for example, as shown in FIGS. 18A and 18B, when the frequency selective reflector 1 includes, in the order from the protective member 21 side, a dielectric layer 5 including a concave and convex structure in which a plurality of a unit structure 10 including a thickness distribution of increasing thickness in a predetermined direction D1 are arranged, and transmitting particular electromagnetic waves; and a reflecting member 2 reflecting particular electromagnetic waves, wherein the unit structure 10 of the dielectric layer 5 includes a plurality of cell regions 11a to 11f of which thickness t1 to t6 differs from one another, the protective member 21 is preferably arranged so as to contact the maximum thickness cell region 11f having the maximum thickness t6 in the unit structure 10 of the dielectric layer 5. Since the maximum thickness portion in the dielectric layer, specifically the maximum thickness cell region in the unit structure of the dielectric layer is plurally present in the dielectric layer, by arranging the protective member as described above, the protective member can be certainly supported. As a result, deflection of the protective member can be effectively suppressed even when the thickness of the protective member is thin. Thus, when the protective member is arranged in the above manner, the thickness of the protective member can be made thinner. For the frequency selective reflector shown in FIGS. 18A and 18B, FIG. 18A corresponds to a cross-sectional view of A-A line in FIG. 18B.

Also, when the protective member is arranged so as not to contact the frequency selective reflector, there are no particular limitations on the distance between the frequency selective reflector and the protective member.

2. Frequency Selective Reflector

The frequency selective reflector in the present disclosure is a member reflecting electromagnetic waves in a particular frequency band to a direction different from a regular reflection direction.

The frequency selective reflector is not particularly limited if it is a member that reflects electromagnetic waves in a particular frequency band to a direction different from the regular reflection direction. The frequency selective reflector may include, for example, a reflecting member that reflects the electromagnetic waves, and the reflecting member may have a reflection phase control function that controls the reflection phase of the electromagnetic waves. Alternatively, the frequency selective reflector may include, for example, in the order from the protective member side, a dielectric layer including a concave and convex structure in which a plurality of unit structures including a thickness distribution of increasing thickness in a predetermined direction is arranged; and transmitting the electromagnetic waves, and a reflecting member that reflects the electromagnetic waves.

The first aspect wherein the frequency selective reflector includes a reflecting member reflecting the electromagnetic waves, and the reflecting member includes a reflection phase control function controlling a reflection phase of the electromagnetic waves; and the second aspect wherein the frequency selective reflector includes, in an order from the protective member side, a dielectric layer including a concave and convex structure in which a plurality of a unit structure including a thickness distribution of increasing thickness in a predetermined direction is arranged, and transmitting the electromagnetic waves; and a reflecting member reflecting the electromagnetic waves, will be hereinafter separately explained.

(1) First Aspect of Frequency Selective Reflector

The first aspect of the frequency selective reflector in the present disclosure includes a reflecting member reflecting the electromagnetic waves, and the reflecting member includes a reflection phase control function controlling a reflection phase of the electromagnetic waves.

(a) Reflecting Member

The reflecting member in the present aspect reflects the electromagnetic waves in a particular frequency band, and is a member including a reflection phase control function controlling the reflection phase of the electromagnetic waves.

In the present aspect, the reflecting member usually includes a wavelength selecting function reflecting only the electromagnetic waves in a particular frequency band. Examples of such a reflecting member may include a frequency selective plate.

Incidentally, the frequency selective reflector is in the same contents as those described in the section “A. Frequency selective reflector” above. For example, FIG. 17B is an example in which the reflecting member 2 is a frequency selective plate, and the reflecting member 2 includes a dielectric substrate 4, and a plurality of reflective element 3 arranged on an electromagnetic wave incident side surface of the dielectric substrate 4.

The shape and the configuration of the reflective element are also in the same contents as those described in the section “A. Frequency selective reflector” above.

In the present aspect, the reflecting member includes a reflection phase control function controlling a reflection phase of the electromagnetic waves. In such a reflecting member, by varying the size and the shape of the reflective element, the resonance frequency can be varied per each reflective element, and the reflection phase of the electromagnetic wave can be controlled; thereby the reflection direction of the electromagnetic wave incident from the predetermined direction can be controlled.

As the reflecting member including the reflection phase control function, a general frequency selective surface can be applied. Although there are advantages and disadvantages in the design of these, it is possible to vary the reflection phase of the electromagnetic wave by varying the size and shape of these reflective element.

The different sizes of the reflective element are appropriately selected depending on the shape of the reflective element.

(b) Other Configurations

The frequency selective reflector of the present aspect may include configurations other than the reflecting member as required.

(i) Ground Layer

The frequency selective reflector of the present aspect may include a ground layer on a surface of the reflecting member that is opposite to the protective member. The ground layer is in the same contents as those described in the section “A. Frequency selective reflector” above.

(ii) Planarizing Layer

The frequency selective reflector of the present aspect may include a planarizing layer on the protective member side surface of the reflecting member. The planarizing layer is in the same contents as those described in the section “A. Frequency selective reflector” above.

(2) Second Aspect of Frequency Selective Reflector

The second aspect of the frequency selective reflector in the present disclosure includes, in an order from the protective member side, a dielectric layer including a concave and convex structure in which a plurality of a unit structure including a thickness distribution of increasing thickness in a predetermined direction is arranged, and transmitting the electromagnetic waves; and a reflecting member reflecting the electromagnetic waves, wherein the unit structure of the dielectric layer includes a plurality of cell regions of which thickness differs from one another; the dielectric layer includes, as the unit structure, at least a first unit structure including three or more of the cell regions of which thickness differs from one another; and a reflection direction of the electromagnetic waves is controlled by controlling a relative reflection phase distribution of the electromagnetic waves by the thickness distribution of the dielectric layer.

The second aspect of the frequency selective reflector in the present disclosure has three embodiments. The frequency selective reflector of each embodiment is the same as three embodiments described in the section “A. Frequency selective reflector” above.

Incidentally, the thickness of each cell region needs not be ½ of the effective wavelength of the electromagnetic wave or an integer multiple thereof.

(3) Other Points of Frequency Selective Reflector

The frequency selective reflector in the present disclosure reflects electromagnetic waves in a particular frequency band to a direction different from a regular reflection direction. The frequency band of the electromagnetic wave is in the same contents as those described in the section “A. Frequency selective reflector” above. Meanwhile, if the frequency band of the electromagnetic wave is too high, the thickness of the protective member needs to be substantially thin, and when a mechanical strength and the like required for protection is considered, attenuation of the electromagnetic wave may not be sufficiently suppressed.

The frequency selective reflector of the present disclosure can be used, for example, as a frequency selective reflector for communication, and is suitable as a frequency selective reflector for mobile communication, among others.

3. Other Configurations

The reflecting structure of the present disclosure may include configurations other than the frequency selective reflector and the protective member as required.

(1) Supporting Member

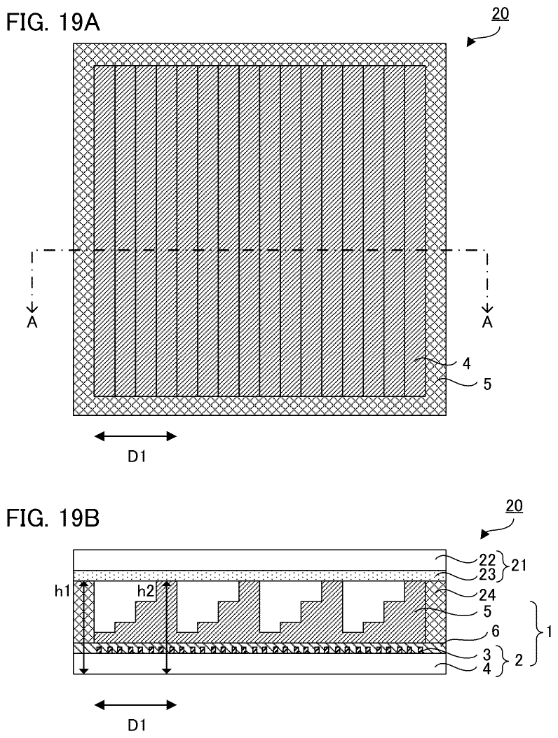

In the reflecting structure of the present disclosure, for example, as shown in FIGS. 19A and 19B, the supporting member 24 is arranged in the outer periphery of the frequency selective reflector 1, and the protective member 21 may be supported by the supporting member 24. In other words, the protective member may be arranged so as to contact the supporting member. By supporting the protective member with the supporting member, deflection of the protective member can be suppressed even when the thickness of the protective member is thin. Also, the frequency selective reflector can be sealed by the protective member and the supporting member, and adhesion of foreign matter to the frequency selective reflector can be suppressed.

The supporting member is not particularly limited if it is non-conductive and is capable of supporting the protective member.

The material of the supporting member is preferably a non-conductive material. Examples of the non-conductive material may include a material used for the protective sheet of the protective member and a material used for the dielectric layer.

The dielectric constant of the supporting member is preferably close to air. Also, the dielectric loss tangent of the supporting member is preferably small. In this case, the effect of the supporting member on the reflection properties of the frequency selective reflector can be substantially eliminated.

The thickness of the supporting member is not particularly limited if it can support the protective member.

In particular, when the frequency selective reflector includes, in the order from the protective member, the dielectric layer and the protective member, the height of the supporting member from the bottom surface of the frequency selective reflector is preferably equal to the height of the maximum thickness portion in the dielectric layer from the bottom surface of the frequency selective reflector.

Specifically, when the unit structure of the dielectric layer includes a plurality of cell regions of which thickness differs from one another, the height of the supporting member from the bottom surface of the frequency selective reflector is preferably equal to the height of the maximum thickness cell region in the unit structure of the dielectric layer from the bottom surface. For example, in FIG. 19B, the height h1 of the supporting member 24 from the bottom surface of the frequency selective reflector 1 is equal to the height h2 of the maximum thickness cell region in the unit structure of the dielectric layer 5 from the bottom surface. Also, for example, as shown in FIG. 19B, when the supporting member 24 is arranged on the same plane as the dielectric layer 5, the thickness of the supporting member is preferably equal to the thickness of the maximum thickness cell region in the unit structure of the dielectric layer, that is, the maximum thickness. The height of the supporting member from the bottom surface of the frequency selective reflector is such as above, whereby the protective member can be certainly supported by both the supporting member and the frequency selective reflector, and deflection of the protective member can be effectively suppressed even when the thickness of the protective member is thin.

As the width of the supporting member, it is not particularly limited if the protective member can be supported, and it is a width in which the supporting member can be arranged in the outer periphery of the frequency selective reflector, and can be, for example, less than the wavelength of the electromagnetic wave.

The supporting member is arranged in the outer periphery of the frequency selective reflector, and for example, may be arranged on a part of the outer periphery of the frequency selective reflector, and may be arranged entirely in the outer periphery of the frequency selective reflector, but is preferably arranged entirely in the outer periphery of the frequency selective reflector. By arranging the supporting member entirely in the outer periphery of the frequency selective reflector, deflection of the protective member can be further suppressed even when the thickness of the protective member is thin. In addition, the frequency selective reflector can be sealed by the protective member and the supporting member, and adhesion of foreign matter to the frequency selective reflector, intrusion of moisture, and the like can be suppressed.

In order to effectively support the protective member, the supporting member may be arranged not only in the outer periphery of the frequency selective reflector but also in a region other than the outer periphery of the frequency selective reflector.

When the supporting member is arranged in a region other than the outer periphery of the frequency selective reflector, the supporting member can be arranged in a region other than the outer periphery of the frequency selective reflector within a range in which the necessary reflection properties can be ensured when the protective member is arranged so as not to be in contact with the frequency selective reflector in the case of the frequency selective reflector of the first aspect.

When the supporting member is also arranged in a region other than the outer periphery of the frequency selective reflector, in the case of the frequency selective reflector of the second aspect, the maximum thickness portion of the dielectric layer may also serve as a supporting member arranged in a region other than the outer periphery of the frequency selective reflector. Further, in the case of the frequency selective reflector of the second aspect, the supporting member and the dielectric layer arranged in the outer periphery of the frequency selective reflector may be formed together. On this occasion, in the dielectric layer, by arranging the maximum thickness portion of the dielectric layer so as to surround the outer periphery of the dielectric layer, the supporting member and the dielectric layer arranged in the outer periphery of the frequency selective reflector can be formed together. Also on this occasion, when the dielectric layer includes individual cell regions separately formed and the block-like cell regions are arranged as described above, the layout of the maximum thickness portion in the dielectric layer may be appropriately adjusted so that the outer peripheral portion of the entire reflecting structure functions as a supporting member.

(2) Fixing Member

When the reflecting structure of the present disclosure is used by being attached to, for example, a wall or the like, a fixing member having a mechanism for attaching the reflecting structure may be arranged on a surface of the frequency selective reflector that is opposite to the protective member side. Also, in order to suppress interference between the installation surface of the wall or the like and the frequency selective reflector, the fixing member may include a structure in which the distance between the installation surface and the frequency selective reflector may be separated by a predetermined distance, and may include a layer of a predetermined thickness having a dielectric constant close to that of air. In order to inhibit interference between the fixing member and the frequency selective reflector, a metal layer may also be arranged between the fixing member and the frequency selective reflector, and the fixing member may also serve as a metal layer. In addition, when the reflecting structure of the present disclosure is attached to a wall or the like, the fixing member may have a mechanism of making the angle in the normal direction of the frequency selective reflector variable so that the deviation between the designed incident direction and reflection direction of the electromagnetic wave and the actual incident direction and reflection direction of the electromagnetic wave can be corrected.

(3) Sealing Member

In the present disclosure, a sealing member may be arranged in the outer periphery of the reflecting structure. When the supporting member is not arranged entirely in the outer periphery of the frequency selective reflector, specifically in the case of the frequency selective reflector of the first aspect when the protective member is arranged so as to be in contact with the frequency selective reflector, or in the case of the frequency selective reflector of the second aspect when the individual cell regions are formed separately and the block-like cell regions are arranged, by arranging the sealing member in the outer periphery of the reflecting structure, the intrusion of foreign matter, moisture, etc. from the outer periphery of the reflecting structure can be suppressed.

As the sealing member, for example, a general caulking material, a barrier tape, or the like can be applied, but is preferably non-conductive.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

The present disclosure will be hereinafter explained with reference to Examples.

### Example 1

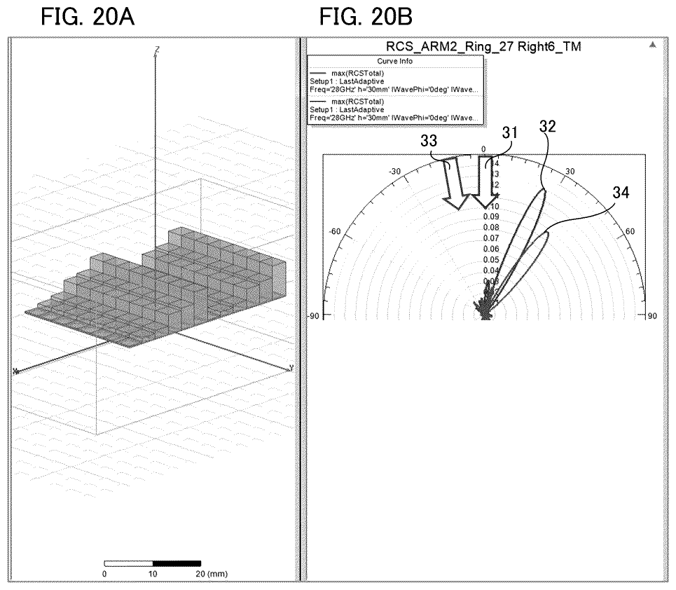

Simulation of the reflection properties of the frequency selective reflector was performed. As the model used in the simulation, as shown in FIG. 20A, the unit structure of the dielectric layer included a thickness distribution in which the thickness increases in one direction, and included six cell regions of which thickness differs from one another, and the dielectric layer was the one in which the unit structure had a periodic structure repeatedly arranged in one direction. Also, in the simulation, the reflecting member was a model in which ring-shaped reflective elements were regularly arranged, resonated at the frequency of the incident wave, and reflected the electromagnetic waves at that frequency. The following parameters were also used in the simulation:
Frequency of the incident wave: 28 GHz
Incident angle of the incident wave: 0°, −10°
The desired reflection angle of the reflected wave: 27°, 37°
The difference in relative reflection phase in neighboring cell regions: 60°.

The results of the simulation are shown in FIG. 20B. If the incident angle was 0°, which means the reflection to incidence from the front direction 31, was shown in solid line indicated as reference sign 32. Also, if the incident angle was −10°, which means the reflection to incidence from −10° direction 33, was shown in solid line indicated as reference sign 34. It can be seen that when the incident angle was 0°, it was reflected to the +27° direction from the regular reflection direction, and when the incident angle was −10°, it was reflected to the +37° direction from the regular reflection direction.

### Example 2

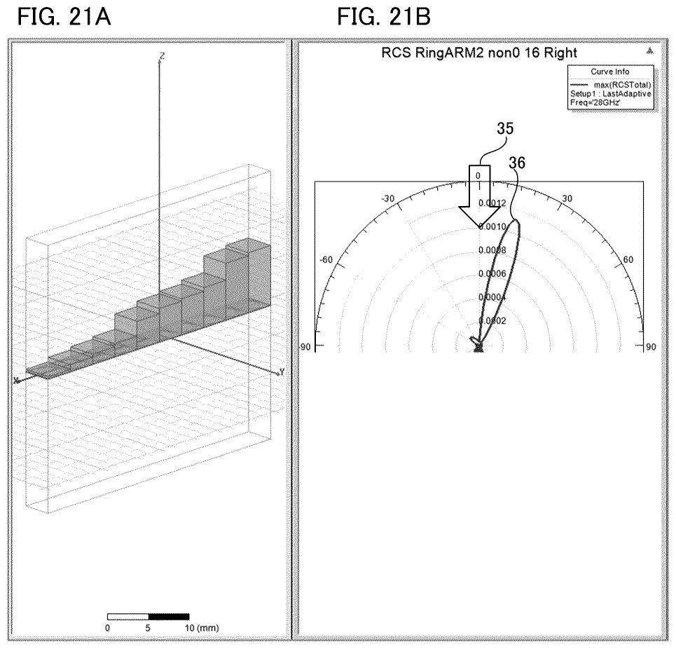

Simulation of the reflection properties of the frequency selective reflector was performed. As the model used in the simulation, as shown in FIG. 21A, the unit structure of the dielectric layer included a thickness distribution in which the thickness increases in one direction, and included ten cell regions of which thickness differs from one another, and the dielectric layer was the one in which the unit structure had a periodic structure repeatedly arranged in one direction. Also, in the simulation, the reflecting member was a model in which ring-shaped reflective elements were regularly arranged, resonated at the frequency of the incident wave, and reflected the electromagnetic waves at that frequency. The following parameters were also used in the simulation:
Frequency of the incident wave: 28 GHz
Incident angle of the incident wave: 0°
The desired reflection angle of the reflected wave: 16°
The difference in relative reflection phase in neighboring cell regions: 36°.

The results of the simulation are shown in FIG. 21B. If the incident angle was 0°, which means the reflection to incidence from the front direction 35, was shown in solid line indicated as reference sign 36. It can be seen that when the incident angle was 0°, it was reflected to +16° direction from the regular reflection direction. Also, the reflection direction of FIG. 21B was closer to the regular reflection direction compared to that of FIG. 20B. This is because the unit structure of the dielectric layer in FIG. 20A had six cell regions, whereas there were ten cell regions in FIG. 21A, and the length of the unit structure in the predetermined direction of increasing thickness was long.

### Example 3

First, in accordance with the model of the reflecting member of Example 1, a copper foil-attached PET film was etched to create a reflecting member in which ring-shaped reflective elements are regularly arranged. Also, a dielectric layer was formed by a 3D printer in accordance with the model of the dielectric layer of Example 1. The dielectric layer was then applied on the reflecting member to create a frequency selective reflector.

The reflection properties of the frequency selective reflector were measured using a compact range measurement system and a network analyzer. The reflection properties of the frequency selective reflector of Example 3 substantially matched with the simulation results of Example 1.

### Example 4

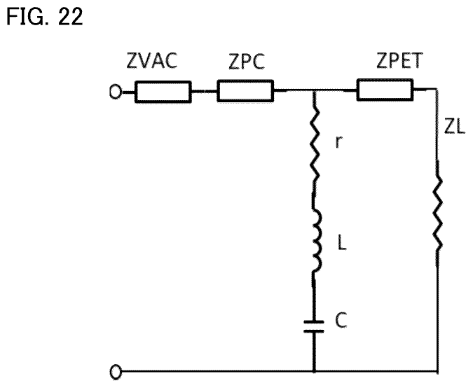

The reflection phase was calculated for a frequency selective reflector with a reflecting member including FSS and a dielectric layer, using a general transmission line equivalent circuit, as shown in FIG. 22, in the analysis of the reflect array. The symbols in FIG. 22 are as follows:
ZVAC: A transmission line with a characteristic impedance of air. The line length is a length obtained by subtracting the thickness of the dielectric layer from a phase observation surface set at any distance farther than the top surface of the dielectric layer.
ZPC: A transmission line with a characteristic impedance of a dielectric layer. The line length is the thickness of the dielectric layer h.
r: Resistance of the ring-shaped reflective element of the FSS.
L: The inductance of the ring-shaped reflective element of the FSS.
C: Capacity of the ring-shaped reflective element of the FSS.
ZPET: A transmission line having a dielectric constant of a dielectric substrate on which the ring-shaped reflective element of FSS is arranged. The line length is the thickness of the dielectric substrate.
ZL: The characteristic impedance of the space on the back surface of the dielectric substrate. The space is filled with air.

As a result, the reflection phase change due to the resonance frequency shift caused by the superposition of the dielectric layers of different thicknesses in the reflection phase was at most several tens of degrees, which was around 25% of the maximum reflection phase 360°, and other reflection phase changes were calculated to be due to wavelength shortening in the dielectric layer. Further, even if the positions of the reflecting member including the frequency selective surface and the dielectric layer are misaligned, the shift is equalized throughout the frequency selective reflector, but it can be concluded that there is little effect on the reflection direction given that the reflection phase with the neighboring cell region may be equal to make the reflected wave to be a plane wave.

### Example 5

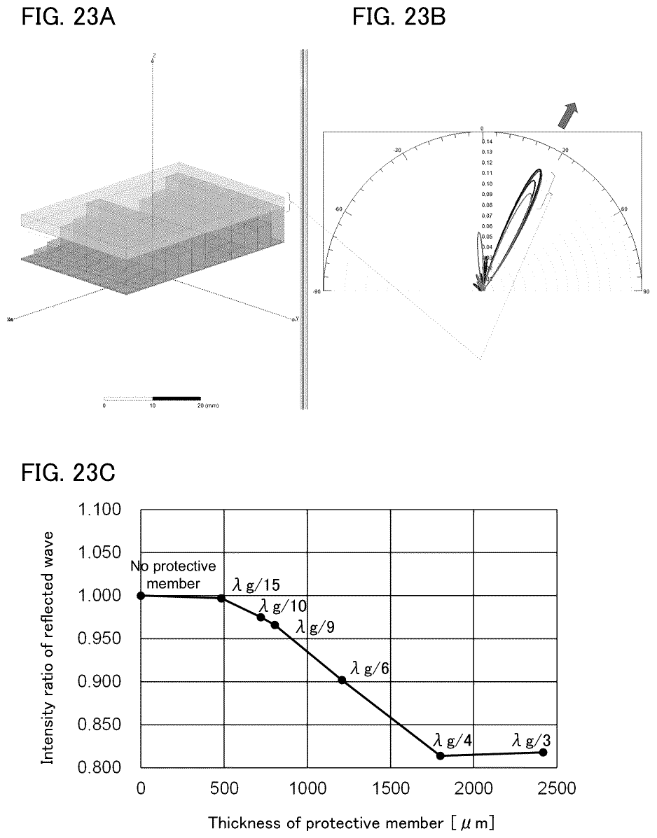

Simulation of reflection properties of the reflecting structure was performed. As the model used in the simulation, as shown in FIG. 23A, the unit structure of the dielectric layer of the frequency selective reflector included a thickness distribution in which the thickness increases in one direction, and included six cell regions of which thickness differs from one another, and the dielectric layer was the one in which the unit structure had a periodic structure repeatedly arranged in one direction. Also, in the simulation, the reflecting member was a model in which ring-shaped reflective elements were regularly arranged, resonated at the frequency of the incident wave, and reflected the electromagnetic waves at that frequency. Also, in the simulation, following parameters were used for the frequency selective reflector. Further, in the simulation, the thickness of the protective member was ⅓ to 1/15 of the effective wavelength λ_{g} of the electromagnetic wave.
Frequency of the incident wave: 28 GHz
Incident angle of the incident wave: 0°
The desired reflection angle of the reflected wave: 27°
The difference in relative reflection phase in neighboring cell regions: 60°.

The results of the simulation are shown in FIG. 23B. FIG. 23C also shows the relationship between the thickness of the protective member and the intensity ratio of the reflected wave when the intensity of the reflected wave when the protective member is not arranged is defined as 1. If the thickness of the protective member was less than λ_{g}/4, the intensity ratio of the reflected wave was increased as the thickness of the protective member decreases. Furthermore, when the thickness of the protective member was λ_{g}/15 or less, the intensity ratio of the reflected wave was substantially constant. This suggested that attenuation of electromagnetic waves can be suppressed by thinning the thickness of the protective member to be less than λ_{g}/4.

### Example 6

Simulation of the reflection properties of the frequency selective reflector was performed. As the model used in the simulation, the unit structure of the dielectric layer included a thickness distribution in which the thickness increases in one direction, and included three, five, or eight cell regions of which thickness differs from one another, and the dielectric layer was the one in which the unit structure had a periodic structure repeatedly arranged in one direction. Also, in the simulation, the reflecting member was a model in which ring-shaped reflective elements were regularly arranged, resonated at the frequency of the incident wave, and reflected the electromagnetic waves at that frequency. Then, in the unit structure of the dielectric layer, the design was performed so that the relative reflection phase of the electromagnetic wave in each cell region was set to a predetermined value.

Next, a dielectric layer was formed by a 3D printer in accordance with the model of the dielectric layer based on the design values described above.

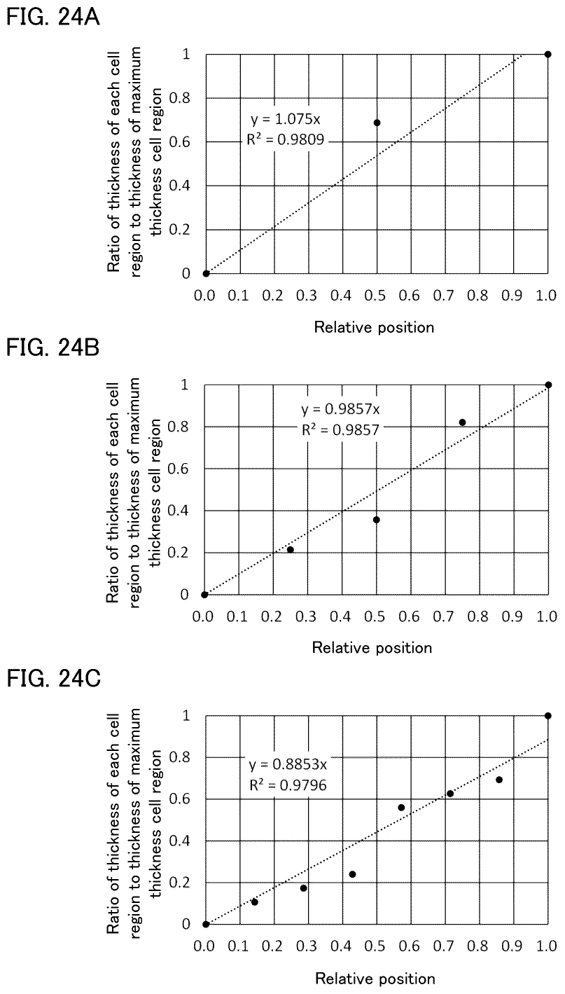

For the obtained dielectric layer, FIG. 24A to 24C show a graph setting: a horizontal axis as a relative position when a central position in the predetermined direction of a minimum thickness cell region is defined as 0, and a central position of the predetermined direction of a maximum thickness cell region is defined as 1; and a vertical axis as a thickness ratio of each cell region with respect to a thickness of the maximum thickness cell region when a thickness of the minimum thickness cell region is defined as 0, and a thickness of the maximum thickness cell region is defined as 1; in which a point corresponding to a central position of the predetermined direction of each cell region and corresponding to a thickness ratio of each cell region with respect to a thickness of the maximum thickness cell region was plotted. FIGS. 24A to 24C are respectively graphs in the case where the number of cell regions configuring the unit structure of the dielectric layer was three, five, and eight. A regression line was then determined from the graphs.

As shown in FIGS. 24A to 24C, the slope “a” and the coefficient of determination R 2 of the regression line were in the predetermined range in all cases.

The reflection properties of the frequency selective reflector were also measured using a compact range measurement system and a network analyzer. All of the reflection properties of the frequency selective reflectors approximately matched with the simulation results.

Therefore, it has been suggested that the desired reflection properties are satisfied if the slope “a” and the coefficient of determination R² of the regression line are in the predetermined range.

### REFERENCE SINGS LIST

1 frequency selective reflector
2 reflecting member
3 reflective element
4 dielectric substrate
5 dielectric layer
6 adhesive layer
7 reflective layer
8 space
10, 10a, 10b unit structure
11a to 11g, 12a to 12f, 13a to 13e cell region
20 reflecting structure
21 protective member
22 protective sheet
23 adhesive layer
24 supporting member
D1 predetermined direction
L length of unit structure in predetermined direction in
which thickness increases
t1, t2, t3, t4, t5, t6 thickness of cell region
T thickness of protective member

1-19. (canceled)

20. A reflecting structure comprising:
a frequency selective reflector reflecting electromagnetic waves in a particular frequency band to a direction different from a regular reflection direction; and
a protective member arranged in an upper side of the frequency selective reflector, wherein
a thickness of the protective member is less than ¼ of an effective wavelength of the electromagnetic waves propagating in the protective member.

21. The reflecting structure according to claim 20,
wherein the frequency selective reflector includes, in an order from the protective member side,
a dielectric layer including a concave and convex structure in which a plurality of a unit structure including a thickness distribution of increasing thickness in a predetermined direction is arranged, and transmitting the electromagnetic waves; and
a reflecting member reflecting the electromagnetic waves,
wherein the unit structure of the dielectric layer includes a plurality of cell regions of which thickness differs from one another;
in each of the unit structure of the dielectric layer, in a graph setting a horizontal axis as a length of the predetermined direction of the unit structure, and setting a vertical axis as a relative reflection phase when the electromagnetic waves are transmitted through the dielectric layer, reflected by the reflecting member and emitted to the protective member side by being transmitted through the dielectric layer again, in the graph, a value of the relative reflection phase of the electromagnetic waves is over −360° and 0° or less, when a point corresponding to a central position of the predetermined direction in each cell region and corresponding to the relative reflection phase of the electromagnetic waves in each cell region are plotted, and a straight line passing through a point corresponding to a minimum thickness cell region having a minimum thickness is drawn, each point is on a same straight line;
the dielectric layer includes, as the unit structure, at least a first unit structure including three or more of the cell region of which thickness differs from one another; and
a reflection direction of the electromagnetic waves is controlled by controlling the relative reflection phase distribution of the electromagnetic waves by the thickness distribution of the dielectric layer.

22. The reflecting structure according to claim 20,
wherein the frequency selective reflector includes, in an order from the protective member side,
a dielectric layer including a concave and convex structure in which a plurality of a unit structure including a thickness distribution of increasing thickness in a predetermined direction is arranged, and transmitting the electromagnetic waves; and
a reflecting member reflecting the electromagnetic waves,
wherein the unit structure of the dielectric layer includes a plurality of cell regions of which thickness differs from one another;
in each of the unit structure of the dielectric layer, in a graph setting: a horizontal axis as a relative position when a central position in the predetermined direction of a minimum thickness cell region having a minimum thickness is defined as 0, and a central position of the predetermined direction of a maximum thickness cell region having a maximum thickness is defined as 1; and a vertical axis as a thickness ratio of each cell region with respect to a thickness of the maximum thickness cell region when a thickness of the minimum thickness cell region is defined as 0, and a thickness of the maximum thickness cell region is defined as 1; when a point corresponding to a central position of the predetermined direction of each cell region and corresponding to a thickness ratio of each cell region with respect to a thickness of the maximum thickness cell region is plotted to obtain a regression line of a below formula (1):
y=ax (1),
a slope “a” of the regression line is 0.7 or more and 1.2 or less, a coefficient of determination of the regression line is 0.9 or more; and
the dielectric layer includes, as the unit structure, at least a first unit structure including three or more of the cell regions of which thickness differs from one another.

23. The reflecting structure according to claim 20,
wherein the frequency selective reflector includes, in an order from the protective member side,
a dielectric layer including a concave and convex structure in which a plurality of a unit structure including a thickness distribution of increasing thickness in a predetermined direction is arranged, and transmitting the electromagnetic waves; and
a reflecting member reflecting the electromagnetic waves,
wherein the unit structure of the dielectric layer includes a plurality of cell regions of which thickness differs from one another;
in each of the unit structure of the dielectric layer, a difference between a minimum thickness and a maximum thickness is 0.2 mm or more and 15 mm or less; and
the dielectric layer includes, as the unit structure, at least a first unit structure including three or more of the cell regions of which thickness differs from one another.

24. The reflecting structure according to claim 23, wherein the reflecting member is a frequency selective plate reflecting only the electromagnetic waves.

25. The reflecting structure according to claim 24, wherein the reflecting member includes a reflection phase control function controlling a reflection phase of the electromagnetic waves.

26. The reflecting structure according to claim 20, wherein the frequency selective reflector includes a reflecting member reflecting the electromagnetic waves; and
the reflecting member includes a reflection phase control function controlling a reflection phase of the electromagnetic waves.

27. The reflecting structure according to claim 20, wherein the protective member is supported by the frequency selective reflector.

28. The reflecting structure according to claim 20, wherein a supporting member is arranged in an outer periphery of the frequency selective reflector, and the protective member is supported by the supporting member.

29. The reflecting structure according to claim 20, wherein the protective member includes, in an order from the frequency selective reflector, an adhesive layer and a protective sheet.

30. The reflecting structure according to claim 21, wherein the reflecting member is a frequency selective plate reflecting only the electromagnetic waves.

31. The reflecting structure according to claim 30, wherein the reflecting member includes a reflection phase control function controlling a reflection phase of the electromagnetic waves.

32. The reflecting structure according to claim 22, wherein the reflecting member is a frequency selective plate reflecting only the electromagnetic waves.

33. The reflecting structure according to claim 32, wherein the reflecting member includes a reflection phase control function controlling a reflection phase of the electromagnetic waves.
